(19) United States
(12) Patent Application Publication
(10) Pub. No.: US 2025/0083769 A1
(43) Pub. Date: Mar. 13, 2025

(54) CYCLOIDAL GEAR AND ELECTRIC BICYCLE DRIVE UNIT WITH CYCLOIDAL GEAR

(71) Applicant: SRAM DEUTSCHLAND GmbH, SCHWEINFURT (DE)

(72) Inventors: HENRIK BRAEDT, HAMBACH (DE); SEBASTIAN HEYNA, HAMBACH (DE)

(73) Assignee: SRAM DEUTSCHLAND GmbH, SCHWEINFURT (DE)

(21) Appl. No.: 18/749,280

(22) Filed: Jun. 20, 2024

(30) Foreign Application Priority Data
Jun. 21, 2023 (DE) 10 2023 116 343.4
Jun. 22, 2023 (DE) 10 2023 116 519.4
Jun. 5, 2024 (DE) 10 2024 115 659.7
Jun. 6, 2024 (EP) 24020183.0

(51) Int. Cl. B62M 11/14; B62M 6/50; B62M 6/55

(52) U.S. Cl. CPC B62M 11/145; B62M 6/50; B62M 6/55

(57) ABSTRACT

A cycloidal gear, an electric bicycle drive unit with cycloidal gear, a freewheel device for the drive unit, and a tachometer sensor device for the drive unit is disclosed. The cycloidal gear comprises a drive shaft device, an cam arrangement and an output shaft device, as well as at least one cycloidal disk device with cycloidal tooth arrangements and at least one opposing cycloidal device with opposing tooth arrangements. At least one of the cycloidal tooth arrangements and/or at least one of the opposing cycloidal tooth arrangements has a relief contour that is setback in relation to the respective profile along a clearance cut area that is arranged outside a load flank sub-area of the respective profile.

This application claims priority to, and/or the benefit of, German Patent Application 10 2023 116 343.4, filed Jun. 21, 2023, German Patent Application 10 2023 116 519.4, filed Jun. 22, 2023, German Patent Application 10 2024 115 659.7, filed Jun. 5, 2024, and European Patent Application 24020183.0, filed Jun. 6, 2024, the contents of which are incorporated by reference herein in their entirety.

### BACKGROUND

Off-road bikes with an electric assist drive are becoming increasingly popular. These bikes, also known as e-mountain bikes or e-MTBs for short, are divided into categories such as “cross-country”, “trail”, “enduro” and “downhill”, for example, and are also used for sporting purposes.

Cycloidal gears are generally known, and this also applies to the use of cycloidal gears as compact, usually single-stage reduction gears for electric assist drives on bicycles.

However, the functional principle of known cycloidal gears is derived from their widespread use in the field of robotics. In this application of cycloidal gears, the focus is primarily on the very high gear ratio that can be achieved with cycloidal gears, which allows the use of small and therefore space-saving and weight-saving, high-speed electric motors in robots, and in particular fulfils the requirement of a completely play-free transmission in both directions of rotation of the cycloidal gear. This makes it possible to meet the particularly high requirements of industrial robots for exact positioning and repeat accuracy in the movement of robot arms. However, high power transmission with a high degree of efficiency is by no means a priority in robotics applications, which is why known cycloidal gears are not optimized with regard to these requirements.

### SUMMARY

According to one aspect, a cycloidal gear for an electric bicycle drive unit, the cycloidal gear includes: a drive shaft device with a cam arrangement, and an output shaft device, wherein the drive shaft device and output shaft device are arranged concentrically with respect to one another and with respect to a central axis of the cycloidal gear. The cycloidal gear also includes at least one cycloidal disk device having at least two approximately cycloidal or cylindrical cycloidal tooth arrangements, and at least one opposing cycloid device having at least two approximately cycloidal or cylindrical opposing tooth arrangements. The at least one cycloidal disk device and the at least one opposing cycloidal device are configured for torque-transmitting, mutually positive-locking engagement. The at least one cycloidal disk device and/or the at least one opposing cycloidal device can be brought into an eccentric-cycloidal relative rolling motion relative to the central axis by means of the cam arrangement of a rotary drive, by means of which in contact areas of drive contact between cycloidal disk profiles of the cycloidal tooth arrangements of the at least one cycloidal disk device and opposing cycloidal profiles of the opposing tooth arrangements of the at least one opposing cycloidal disk device. Driving forces can be transmitted in the circumferential direction of the cycloidal gear at least within a respective load flank sub-area of the respective profile of the respective tooth arrangement. At least one of the cycloidal tooth arrangements or the opposing tooth arrangements has a relief contour that is setback relative to the profile along a clearance cut area that is arranged outside the respective load flank sub-area of the respective profile of the respective tooth arrangement.

### BRIEF DESCRIPTION OF THE FIGURES

In the drawings:

FIG. 1 shows a schematic outline of an e-mountain bike with an electric bicycle drive unit with cycloidal gear in a schematic drive-side side view;

FIG. 2 shows a cycloidal disc of a cycloidal disc device of the cycloidal gear according to FIG. 1 with two partially shown opposing cycloidal devices in the form of roller sets;

FIG. 2A shows a schematic enlarged detail of the cycloidal disc according to FIG. 2;

FIG. 3 shows another schematic enlarged detail of the cycloidal disc as shown in FIG. 2;

FIG. 3A shows, within a symbolic outline of FIG. 2, the location of the enlarged FIG. 2 detail shown in FIG. 3;

FIG. 4 shows another schematic enlarged detail of the cycloidal disc as shown in FIG. 2;

FIG. 4A shows, within a symbolic outline of FIG. 2, the location of the enlarged FIG. 2 detail shown in FIG. 4;

FIG. 5 shows a first embodiment of a bicycle drive unit with cycloidal gear according to FIGS. 1 to 4 in a longitudinal sectional view;

FIG. 6 shows the bicycle drive unit with cycloidal gear according to FIGS. 1 to 5 in a partially sectioned oblique view without a housing tube;

FIG. 6A shows the bicycle drive unit with cycloidal gear according to FIG. 6 including the housing tube;

FIG. 7 shows an electronics assembly and sensor arrangement of the bicycle drive unit according to FIGS. 1 to 6A with three sensor devices;

FIG. 8 shows two electronics assemblies and a sensor device of the bicycle drive unit according to FIG. 1 to FIG. 7;

FIG. 9 shows an axial freewheel device of the bicycle drive unit according to FIGS. 1 to 8 in a perspective oblique view;

FIG. 9A shows a ratchet driver and claw ring of the axial freewheel device according to FIG. 9;

FIG. 10 shows the bicycle drive unit with cycloidal gear according to FIGS. 1 to 8 with the axial freewheel device according to FIGS. 9 and 9A in a perspective, partial longitudinal section;

FIG. 11 shows a schematic representation of a second embodiment of a cycloidal gear;

FIG. 12 shows a schematic representation of a third embodiment of a cycloidal gear;

FIG. 13 shows a further embodiment of a bicycle drive unit with cycloidal gear according to FIGS. 1 to 4 in a longitudinal sectional view similar to FIG. 5;

FIG. 14 shows the bicycle drive unit with cycloidal gear according to FIGS. 1 to 4 and 13 in a partially sectioned oblique view without a housing tube, in a perspective representation similar to FIG. 6;

FIG. 14A shows the bicycle drive unit with cycloidal gear according to FIG. 14 including housing tube, in a perspective representation similar to FIG. 6A;

FIG. 15 shows an electronics assembly and sensor arrangement with three sensor devices of the bicycle drive unit with cycloidal gear according to FIGS. 13 to 14A, in a perspective oblique view similar to FIG. 7;

FIG. 16 shows an axial freewheel device of the bicycle drive unit according to FIGS. 13 to 15, in perspective oblique view similar to FIG. 9;

FIG. 16A shows a ratchet driver and claw ring of the axial freewheel device according to FIG. 16 similar to FIG. 9A;

FIG. 17 shows the bicycle drive unit with cycloidal gear according to FIGS. 1 to 4 and 13 to 15 with the axial freewheel device according to FIGS. 16 and 16A in a perspective, partial longitudinal section similar to FIG. 10;

FIG. 18 shows a claw disc, claw ring and ratchet disc of the axial freewheel device according to FIGS. 16 to 17 in a perspective oblique view;

FIG. 19 shows a housing tube with transmission torque support of a bicycle drive unit with cycloidal gear according to FIGS. 1 to 4 and 13 to 18 in a perspective quarter section;

FIG. 20 shows a bicycle drive unit with cycloidal gear e.g. according to FIGS. 1 to 4 and 13 to 19 together with an energy storage device in a partially sectioned perspective view with an open battery hatch; and

FIG. 21 shows the bicycle drive unit according to FIG. 20 with a closed battery hatch.

Other aspects and advantages of the embodiments disclosed herein will become apparent upon consideration of the following detailed description, wherein similar or identical structures have similar reference numerals.

### REFERENCE SIGNS

1 Bicycle
2 Suspended Rear Frame
AC1, AC2 Clearance Cut Area
AD Cycloidal gear central axis
AE Cam Arrangement
AL1, AL2 Load Flank Area
ALA Antenna Led Assembly
AP1 Electronics Assembly 1
AP2 Electronics Assembly 2
AR Rotor Assembly
BBL Left Bottom Bracket Bearing
BBR Right Bottom Bracket Bearing
BC, BC1, BC2 Cam Bearing
BCR Bearing Cap Right
BOL Output Bearing Left
BOR Output Bearing Right
BOS Stator Bobbin
BRD Differential Rotor Bearing
BRL Rotor Bearing Left
BRR Rotor Bearing Right
BS Bearing Seal
BSL Output Shaft Bearing Left
BSR Output Shaft Bearing Right
BST Stop Bracket
BSW Swivel Bolt
CA Cyclo-Acbar Transmission
CC Coil Carrier
CD1, CD2 Contact Area
CG Cycloidal Gear
CHL Housing Cover Left
CHR Housing Cover Right
CL Claw Ring
CO Collar Recess
CP Contact Point
CR Rotor Core
CS Sprocket Cassette
CSC Sensor Coil Connection
CST Stator Coil
CT1 Cycloidal Tooth Arrangement (Outer)
CT2 Cycloidal Tooth Arrangement (Inner)
CW Counter Wall
DA Freewheel Output Disk
DC1, DC2 Cycloidal Disk Device
DDR Ratchet Disc Driver
DF Magnetic Flux Director
DI Cam Disk
DMC Claw Ring Claws
DMN Claw Ring Slant Notch
DMS Claw Ring Spring Holder
DMT Claw Ring Through Holes
DO Output Claw Disc
DOC Claw Disc Claws
DP Driving Protrusion
DR Ratchet Disc
DRC Ratchet Disc Cutout
DRP Ratchet Disc Pin
DSD Drive Shaft Device
DT Tachometer Driver
DU Electric Bicycle Drive Unit
EA Eccentric Axis
ED Deformation Element
EE Electronics Enclosure
ES Energy Storage Device
FA Axial Freewheel Device
FD1, FD2 Driving Force
FM1 Rear Mounting Axis
FM2 Front Mounting Axis
FN1, FN2 Resulting Normal Force
FP Primary Freewheel
FPP Primary Freewheel Pawl
FR1, FR2 Radial Force
FS Sprag Body Freewheel
FT Torque Flange
CM Compur Gear
HB Battery Hatch
HC Circuit Board Holder
HDT Drive Housing Torque Recess
I′F Front Frame Interface
I′R Rear Frame Interface
MA Clutch Actuation Movement
MC Eccentric-Cycloidal Rolling Motion
MD Electric Motor Device
MI Rotational Input Motion
MO Rotational Output Motion
MP Permanent Magnet
MS Swivel Movement
NR Retainer Nut
OC1 Opposing Cycloidal Device (Outer)
OC2 Opposing Cycloidal Device (Inner)
OF Output Flange
OR Output Ring
OT1 Opposing Tooth Arrangement (Outer)
OT2 Opposing Tooth Arrangement (Inner)
PA Axial Protrusions
PC1, PC2 Cycloidal Profile
PD Pedal Crank
PE Stator End Plate
PF Press Fit
PFT Torque Flange Thrust Projection
PL Latching Protrusion
PO1, PO2 Opposing Profile
POP Press-On Projection
PP Push Profile
PR1, PR2 Relief Contour
PRS Setback Dimension
PT Collar Protrusion
RC Chain Ring
RDC Ratchet Driver Slant Cam
RDD Claw Ring Ratchet Driver
RDR Ratchet Driver Ratchet Toothing
RDS Ratchet Driver Spring Holder
RE Engagement Recess
RG Gear Ratio
RHn Housing Roller (N=1 . . . 25)
RHP Housing Roller Pin
RHR Housing Roller Pin Receptacle
RL Latching Recess
RMn Rotational Movement (N=1 . . . 5)
RO Output Roller
ROP Output Roller Pin
ROR Output Roller Pin Receptacle
RR Roller Thrust Ring
RRB Radial Reinforcement Bridge
SAE Axial End Stopp
SB Bottom Bracket Shaft
SBL Bearing Spacer Left
SBR Bearing Spacer Right
SCR Rotor Carrier Sleeve
SCT Tachometer Clamping Spring
SD Stator Device
SE Engagement Slot
SF Axial Freewheel Locking Screw
SO Output Shaft
SP Chainwheel Spider
SR Rotor Shaft
SRC Claw Ring Return Spring
SSP Speed Sensor Element
ST Stator Tooth
STM Tachometer Sensor Element
TC Torque Cantilever
TD1, TD2 Drive Toothing
TDT Tachometer Disc Teeth
TE Tachometer Element
TGS Gearbox Support Torque
TH Housing Tube
TM1 Motor Torque
TM2 Gearbox Torque
TMS Tachometer Sensor Device
TP Power Train
TRL Rider Torque Left
TRR Rider Torque Right
TS Torque Sensor
WB Bicycle Wheel
WCT Cycloidal Wave/Tooth
WGL Gearbox Wall Left
WGR Gearbox Wall Right
WS Stator Connection Wires
WSL Gearbox Seal Left
WSR Gearbox Seal Right
WST Stop Wall

### DETAILED DESCRIPTION

The present disclosure relates to a cycloidal gear, an electric bicycle drive unit, an axial freewheel device for the drive unit, and a tachometer sensor device for the drive unit.

In the following description, location or directional information such as “left”, “right”, “front”, “rear”, “top”, “bottom”, “side view” etc. that is not further specified corresponds to a rider's perspective on a bicycle.

The cycloidal gear according to the present disclosure is suitable for an electric bicycle drive unit and comprises a drive shaft device with a cam arrangement and an output shaft device, wherein the drive shaft device and the output shaft device are arranged concentrically to one another and to an imaginary central axis of the cycloidal gear.

Furthermore, the cycloidal gear comprises at least one cycloidal disc device together with at least two at least approximately cycloidal or cylindrical cycloidal tooth arrangements and at least one opposing cycloidal device together with at least two at least approximately cycloidal or cylindrical opposing cycloidal tooth arrangements.

“At least approximately cycloidal” is to be understood as meaning that in a real gearbox the mathematically ideal, epicycloidal outer profiles of a cycloidal disc or hypocycloidal inner profiles, for example of the toothing fixed to the housing, can only be achieved approximately. Furthermore, the term “at least approximately cycloidal” is used because the cycloidal gear according to the present disclosure specifically deviates from the mathematical-theoretical cycloidal profiles, as will be described below.

It should also be noted that the terms “cycloidal” and “at least approximately cycloidal” would, strictly speaking, each have to read, for example, “cyclo-cylindrical”, since the term “cycloidal” describes a planar, i.e. two-dimensional curve, while the present disclosure relates to cycloidal tooth arrangement with a thickness dimension, i.e. three-dimensional cylindrical bodies with a circular or cycloidal cross-sectional shape. However, for the sake of simplicity, the term “cycloidal” is used instead of “cyclo-cylindrical”.

In the example of a frequently encountered standard cycloidal gear, one or two cycloidal disc devices together with two or four cycloidal tooth arrangements are usually found. In the so-called Cyclo-Acbar transmissions (see document DE02016109150A1) and compur gears (see document CA291312A), there are always two cycloidal disc devices. The standard cycloidal gear has two cycloidal tooth arrangements, namely an outer cycloid on the outer circumference of the at least one cycloidal disc and the opposing tooth arrangements formed by the profiles of typically cylindrical holes in the at least one cycloidal disc. The so-called compur gear also has two cycloidal tooth arrangements in the form of cycloidal profiles of an outer cycloidal disc and an inner cycloidal disc, respectively. The so-called Cyclo-Acbar transmission also has two cycloidal tooth arrangements, which are formed by the outer profiles of two mutually fixedly connected cycloidal discs.

With regard to the number of “at least one opposing cycloidal device”, it should be noted that the standard cycloidal gear and the Cyclo-Acbar transmission each have two opposing cycloidal devices together with two opposing tooth arrangements, whereas in the compur gear the two opposing tooth arrangements are typically in the form of a single-piece component, which is also known as a “pin ring”.

With regard to the number of opposing tooth arrangements, the standard cycloidal gear typically has two opposing tooth arrangements, namely the outer rollers, which are usually fixed to the housing, and the inner rollers, which usually form the output. The Cyclo-Acbar transmission also has two opposing tooth arrangements, for example in the form of roller sets, of which one opposing tooth arrangement is fixed to the housing and the other forms the output. In the compur gear, an intermediate disc or the so-called pin ring usually forms the opposing cycloid in one piece for both the cycloid disc and the hollow cycloid.

In the cycloidal gear according to the present disclosure, the at least one cycloidal disc device and the at least one opposing cycloidal device are furthermore configured for a torque-transmitting, mutually positive-locking engagement, wherein the at least one cycloidal disc device and/or (“or” is preferred, “and” is also possible) the at least one opposing cycloidal device can be brought into an eccentric-cycloidal relative rolling motion relative to the central axis by means of the cam arrangement by means of a rotary drive.

Here, for example, either the cycloidal disc is movable and the opposing cycloidal device is fixed to the housing, or (which is the case with the compur gear, for example) the situation is kinematically reversed. Depending on the design of the gear and its connection to connection assemblies, both the cycloidal disc and the opposing cycloidal device can also be movable. In the case of multiple cycloidal discs (in the widely used standard cycloidal gear, in particular to reduce the unbalance), the cam arrangement can accordingly comprise multiple eccentric devices mutually connected in a rotationally fixed manner.

Due to this relative rolling motion, driving forces can be transmitted in the circumferential direction of the cycloidal gear in contact areas between the at least one cycloidal disc device and the at least one opposing cycloidal device by means of driving contact between cycloidal disc profiles of the cycloidal tooth arrangements of the at least one cycloidal disc device and opposing cycloidal profiles of the opposing cycloidal tooth arrangements of the at least one opposing cycloidal device, at least within a respective load flank sub-area of the respective profile of the respective tooth arrangement.

The cycloidal gear according to the present disclosure is characterized by the fact that at least one of the cycloidal tooth arrangements and/or at least one of the opposing tooth arrangements has a relief contour that is setback relative to the profile along a clearance cut area arranged outside the respective load flank sub-area of the respective profile of the respective tooth arrangement.

The advantages that can be achieved in this way, in particular improved efficiency, noise reduction and reduced heat generation, are discussed in detail in the description of the figures.

The present disclosure is applicable to any type of cycloidal gear, including in particular the single-disc or multi-disc cycloidal gear referred to above as “standard cycloidal gear” with one or more cycloidal disc devices and with two opposing cycloidal devices. The cycloidal tooth arrangements of the cycloidal disc devices each engage in parallel and together, but 180° out of phase with the opposing tooth arrangements of the opposing cycloidal devices.

The present disclosure is furthermore also applicable to so-called compur gears. Compur gears have at least one inner cycloidal disc device, at least one outer cycloidal disc device and a cam disc that rotates eccentrically in a positive-locking manner with the profiles as an opposing cycloidal device between the profiles of the inner cycloidal disc device and the outer cycloidal disc device. The cam disc is also referred to as a “pin ring” in some embodiments of compur gears. At least one of the inner cycloidal disc device and outer cycloidal disc device can be rotated about the central axis of the cycloidal gear.

The present disclosure is also applicable to so-called Cyclo-Acbar transmissions. Cyclo-Acbar transmissions have at least two rotationally rigidly mutually connected cycloidal disc devices and two opposing cycloidal devices, wherein at least one of the opposing cycloidal devices is rotatable about the central axis of the cycloidal gear.

Compur gears and Cyclo-Acbar transmissions have the particular advantage that the respective gear output rotates concentrically to the gear drive without the need for pin or roller arrangements that penetrate the cycloidal discs in corresponding cylindrical holes, as is the case with standard cycloidal gears.

In an embodiment, the relief contour forms a smooth transition at transitions to the respective profile of the respective tooth arrangement and/or at transitions to the load flank sub-areas, which means that its first mathematical derivative is continuous. This also serves to reduce noise and increase the load capacity and service life of the cycloidal gear.

In another embodiment, the arc length of the relief contour is between 60% and 85%, or between 65% and 80% of the arc length of the entire profile of the respective tooth arrangement (with the arc length understood in the mathematical sense as the length of the profile). This means that the drive torque can be transmitted unchanged in the area of the original curve, whereby static over-determination and undesirable radial forces are minimized in the area of the relief contour.

In an embodiment, one of the opposing cycloidal devices represents a rotary output or drive of the cycloidal gear engaged with a first cycloidal disc device, wherein the second opposing cycloidal device forms a torque opposing support for torque transmission in the cycloidal gear, wherein the torque opposing support engages with the second cycloidal disc device and is may be fixedly connected to a housing of the cycloidal gear. In other words, this means that one of the opposing cycloidal devices is fixed to the housing.

In another embodiment, contact areas of at least one of the opposing tooth arrangements comprise polymer material to increase the elasticity during torque transmission between the cycloidal disc device and the opposing cycloidal device. This can be realized, for example, in the form of rollers made of polymer material or by metallic rollers coated with polymer material on one or both opposing cycloidal devices. In this way, the costs, noise and weight of the cycloidal gear in particular can be reduced.

The present disclosure further relates to an electric drive unit for a bicycle for arrangement in a bottom bracket area of a bicycle frame. The drive unit comprises a bottom bracket shaft for mounting pedal cranks, an electric motor device with a stator device and a rotor assembly arranged on a rotor shaft, wherein the rotor shaft is arranged coaxially to the bottom bracket shaft, a freewheel arrangement with at least one axial freewheel device, a sensor arrangement with at least one sensor device, at least one electronics assembly for controlling the motor device and/or for processing signals from the sensor device, an output shaft for transmitting drive power to a bicycle power train, and a gear device with a cycloidal gear.

The bicycle drive unit is characterized by the fact that the cycloidal gear may be hermetically encapsulated, at least liquid-tight, with respect to the motor device.

In an embodiment, the cycloidal gear is encapsulated at least in a liquid-tight manner with respect to multiple or all of the motor device, freewheel arrangement, sensor arrangement and electronics assembly.

This improves the lubrication and maintainability of the cycloidal gear and the entire drive unit, and also increases the service life of the drive unit by protecting the other components of the drive unit from lubricants present in the cycloidal gear.

In another embodiment, the rotor shaft of the motor device is mounted exclusively in the cycloidal gear unit, and the rotor assembly is arranged on the rotor shaft in the region of a flying end of the rotor shaft. This arrangement facilitates the hermetic or at least liquid-tight encapsulation of the cycloidal gear with respect to the other assemblies of the drive unit, and also improves the concentricity and the tolerance situation between the motor device and the gear device.

In yet another embodiment, the end of the rotor shaft on the gear side is mounted inside a gear output shaft. This also serves to improve concentricity, simplify mounting, improve tolerances and simplify the design of the drive unit. In addition, a rotor bearing with a large support width is obtained in this way.

The present disclosure also relates to a drive unit, with an axial freewheel device, and to an axial freewheel device for such a drive unit.

The axial freewheel device has coupling elements for decoupling the output shaft of the drive unit from the gear device of the drive unit and is essentially disc-shaped. The axial freewheel device is designed to transmit a gearbox torque through the coupling elements in the axial direction, relative to the bottom bracket shaft of the drive unit. The essentially disc-shaped axial freewheel device has the particular advantage of being particularly space-saving and simultaneously having a high specific torque capacity.

In an embodiment, one, or multiple, or all of the coupling elements of the axial freewheel device, to consist essentially of a polymer material. This saves costs and weight in particular and results in a particularly low-noise axial freewheel device.

In another embodiment, the axial freewheel device has a control device for active control or movement, respectively, of the coupling elements depending on the direction of rotation. This further reduces noise development, wear and undesirable drag torques of the axial freewheel device.

The present disclosure further relates to a drive unit as described above, with a tachometer sensor device, and to a tachometer sensor device for such a drive unit.

The tachometer sensor device comprises a tachometer sensor element and a tachometer element connectable to the bottom bracket shaft of the drive unit for contactless measurement of the speed of the bottom bracket shaft. The tachometer element and tachometer sensor element are arranged on opposite sides of a wall of an output shaft section of the drive unit through which a gearbox torque of the drive unit can flow. In this way, the tachometer sensor device can be integrated into a drive unit in an extremely space-saving manner and the integration of multiple sensor devices of an electronics assembly is facilitated.

The tachometer element is arranged in an inner area of an axial freewheel device of the drive unit, which leads to a further space saving.

In an embodiment, the electronics assembly of the drive unit comprises at least two of the three, or all three, sensor devices: 1. tachometer sensor device with a tachometer sensor element for measuring the speed of the bottom bracket shaft, 2. torque sensor device with a torque sensor element for measuring an elastic deformation of a deformation element of an output shaft section, and 3. tachometer sensor device with a tachometer sensor element for measuring a speed of a bicycle wheel.

In another embodiment, the electronics assembly comprises a circuit board device which is in the shape of a circular ring or circular-ring segment and on which essentially all electronic assemblies and electronic components of the at least two sensor devices are arranged.

This integration of multiple or all sensor devices into a single electronics assembly is made possible in particular by the aforementioned tachometer sensor device, and leads to considerable simplifications and cost savings as well as to increased reliability of the drive unit.

In the following, embodiments of the subject matter of the present disclosure are described by way of example with reference to the associated figures.

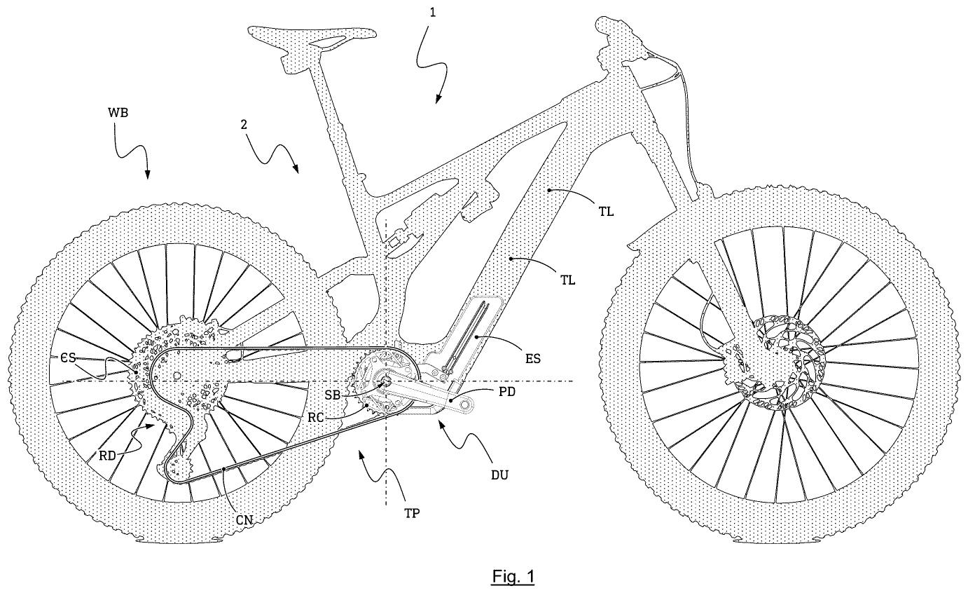

FIG. 1 shows a schematic outline of a mountain bike with an electric bicycle drive unit DU with cycloidal gear CG according to the present disclosure in a schematized, drive-side side view. The mountain bike has a main bicycle frame 1 with a sprung rear frame 2. The electric bicycle drive unit DU comprises an energy storage device ES, which is arranged, for example, in a down tube TL of the main frame 1. In addition to the drive unit DU, the power train TP of the mountain bike comprises a chain ring RC, a rear derailleur RD, a multiple sprocket cassette CS and a drive chain CN.

The drive unit DU is designed as a mid-mounted motor, i.e. arranged in the area of the bottom bracket shaft SB. In the present case, the bottom bracket shaft SB is contained in the drive unit DU.

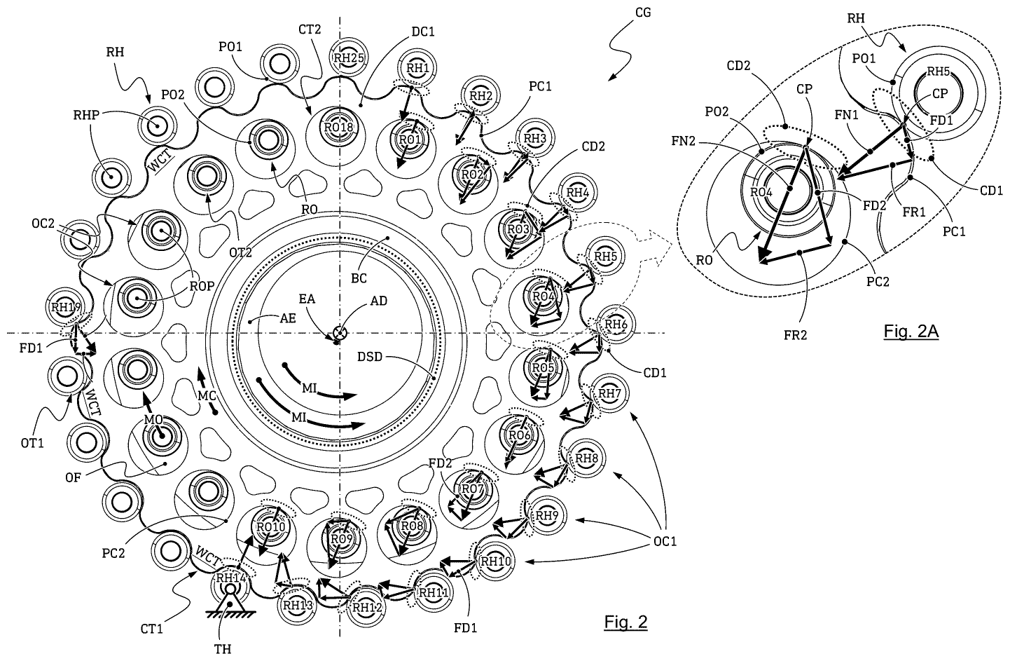

FIG. 2 shows a cycloidal disc device DC1 of the cycloidal gear CG of the drive unit DU according to FIG. 1. Furthermore, FIG. 2 contains two partially depicted opposing cycloidal devices OC1, OC2 in the form of roller sets with housing rollers RH and output rollers RO (fixed on a housing tube TH of the drive unit DU) as well as a drive shaft device DSD with an essentially cylindrical cam arrangement AE with an eccentric central axis EA of the cylinder surface of the cam arrangement AE.

In this embodiment, the cycloidal disc device DC1, DC2, which may be made of aluminium for weight reasons, is mounted on the cam arrangement AE of the drive shaft device DSD by means of a cam bearing BC in such a way that a rotational input motion MI of the drive shaft device DSD about the cycloidal gear central axis AD, in conjunction with a drive contact between a cycloidal profile PC1 of the cycloidal disc device DC1, DC2 with opposing profiles PO1 of the housing rollers RH in contact areas CD1, leads to an eccentric-cycloidal rolling motion MC of the cycloidal disc device DC1, DC2 relative to the roller sets RH, RO.

This eccentric-cycloidal rolling motion MC of the cycloidal disc device DC1, DC2 has an eccentric-circular motion component, which corresponds to the drive shaft speed and the eccentric-circular motion of the central axis of the cam arrangement AE about the cycloidal gear central axis AD, as well as a centric-circular motion component about the cycloidal gear central axis AD, which is slowed down in accordance with the gear ratio of the cycloidal gear CG.

Since the gear ratio of a cycloidal gear CG is calculated as a quotient of the number of teeth of the cycloidal disc device DC1, DC2 (in this case 24 cycloidal disc waves WCT or cycloidal disc teeth) and the difference between the number of teeth of the opposing cycloidal device OC1 (in this case 25 housing rollers RH or housing teeth), this results in a gear ratio of RG=24/(25−24)=24.

This therefore means that the cycloidal disc device DC1, DC2 rotates once about its own axis, which coincides with the central axis EA of the cylinder surface of the cam arrangement AE, when the drive shaft device DSD and thus the cam arrangement AE have performed 24 rotations. This slow rotation of the cycloidal disc device DC1, DC2 about its own axis EA is transmitted to the output rollers RO by means of drive contact in contact areas CD2, whereby the essentially cylindrical inner cycloidal profiles PC2 of the cycloidal disc device DC1, DC2 simultaneously roll on the surfaces of the output rollers RO in a cycloidal-circulating manner.

In this way, the eccentric-cycloidal rolling motion MC of the cycloidal disc device DC1, DC2 is converted back into a rotational output motion MO which is concentric to the cycloidal gear central axis AD of the drive shaft device DSD and is communicated to an output flange OF of the cycloidal gear CG.

In FIG. 2 and in the corresponding enlarged detail according to FIG. 2A, the contact areas CD1 and CD2, in which the drive contact takes place between the cycloidal disc profiles PC1, PC2 and the opposing cycloidal profiles of the opposing tooth arrangements OT1, OT2 of the opposing cycloidal devices OC1, OC2, i.e. the housing rollers RH and the output rollers RO, are each highlighted by means of dotted ellipses.

In these contact areas CD1 and CD2, normal forces FN1, FN2 are transmitted between the housing rollers RH or the output rollers RO and the respective cycloidal profiles PC1, PC2, whereby the respective direction of the respective normal forces FN1, FN2 is naturally perpendicular to the respective momentary contact surface at the contact point CP between the respective roller profile PO1, PO2 and the respective cycloidal profile PC1, PC2.

However, only the force components of the normal forces FN1, FN2 running in the circumferential direction, i.e. the driving forces FD1, FD2 according to FIG. 2 and FIG. 2A, contribute to the transmission of the actual driving forces and thus torques and power in the cycloidal gear CG.

On the other hand, the force components of the normal forces FN1 running in the radial direction of the cycloidal gear CG, i.e. the radial forces FR1, FR2 according to FIG. 2 and FIG. 2A, do not transmit any effective torque and therefore do not transmit any drive power. Rather, the radial forces FR1, FR2 merely lead to stresses in the cycloidal gear CG.

In contrast to the merely schematic representation in FIG. 2 and FIG. 2A, the radial forces FR1, FR2 running in the radial direction of the cycloidal gear CG actually also act on the respective contact point CP in the sense of a vectorial force decomposition. The respective arrows of the radial forces FR1, FR2 in FIG. 2 and FIG. 2A are only shifted parallel along the direction of the circumferential forces FD1, FD2 for illustration purposes, so as not to overload the drawings by adding complete force parallelograms. However, this does not alter the correctness of the vectorial force decomposition shown.

FIG. 2 thus shows that effective driving forces and drive torques are transmitted mainly at those points between the cycloidal disc device DC1, DC2 and the roller sets RH, RO at which the instantaneous normal forces FN1, FN2 have a significant force component FD1, FD2 in the circumferential direction.

This is primarily and approximately mainly the case with the housing rollers RH4-RH12 and the output rollers RO3-RO8 in the moment corresponding to the illustration in FIG. 2 and with the illustrated relative position of the cycloidal disc device DC1, DC2 and roller sets RH, RO. In the case of all other housing rollers RH and output rollers RO, the radial force component FR1 or FR2 predominates, which does not transmit any drive power, but merely leads to stress in the gear.

An analogous situation also exists for the remaining housing rollers RH and output rollers RO, which (with the exception of housing roller RH19) are not specifically designated in FIG. 2 and are not specifically provided with further force vectors in FIG. 2. However, none of these remaining housing rollers RH and output rollers RO transmit any drive power, since any force components FD1, FD2 in the circumferential direction of the cycloidal gear CG merely counteract the driving force components FD1, FD2 of the housing rollers RH1-RH14 or the output rollers RO1-R10, as shown in FIG. 2 using the example of the output roller RH19.

In cycloidal gears according to the prior art, this means that a considerable proportion of the forces between the cycloidal tooth arrangements CT1, CT2 of the cycloidal disc devices DC1, DC2 and the opposing tooth arrangements OT1, OT2 of the opposing cycloidal devices OC1, OC2 do not contribute to the transmission of drive power through the gear, but merely lead to elastic stresses in the gear. It is apparent to a person skilled in the art that such stresses merely lead to undesirable friction and wear in the transmission.

The greater or less precise the manufacturing tolerances of the components or assemblies involved in the force transmission, the greater these elastic stresses in cycloidal gears without contributing to the transmission of the drive power. Conversely, this means that conventional cycloidal gears must be manufactured with particularly low manufacturing tolerances in order to minimize such stresses and the associated disadvantages. This may be feasible when cycloidal gears are used in robotics, since industrial robots are cost-intensive capital goods, and since the use of cycloidal gears in industrial robots focuses less on the aspects such as efficiency, heat generation or power loss, and more on the exact and reproducible positioning of the respective rotor arm, even when the direction of rotation of the drive is reversed.

However, the cycloidal gear CG according to the present disclosure is intended for use in an electric auxiliary drive of a bicycle, in which conversely aspects such as positioning accuracy, repeat accuracy and torque transmission in both directions are practically irrelevant. Rather, the focus in this application is on maximizing efficiency and service life while simultaneously minimizing the mass, noise and weight of the cycloidal gear CG.

With this background and with the realization that in each case only some of the housing rollers RH or output rollers RO and only corresponding sub-areas of the cycloidal disc profiles are involved in the transmission of drive power by the cycloidal gear CG, in the case of the cycloidal gear CG according to FIGS. 1 to 10, the cycloidal tooth arrangements CT1 and CT2 have a relief contour PR1, PR2 that is setback relative to the profile PC1, PC2 along a clearance cut area AC1, AC2, which is located outside the load flank sub-area AL1, AL2 of the respective profile PC1 and PC2 of the respective tooth arrangement CT1 and CT2 that is mainly involved in the power transmission.

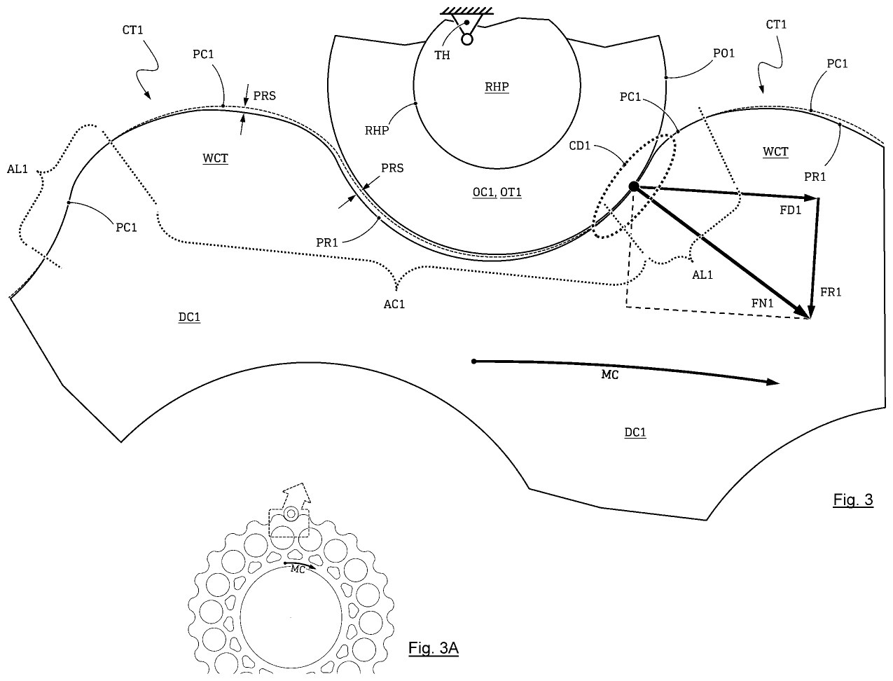

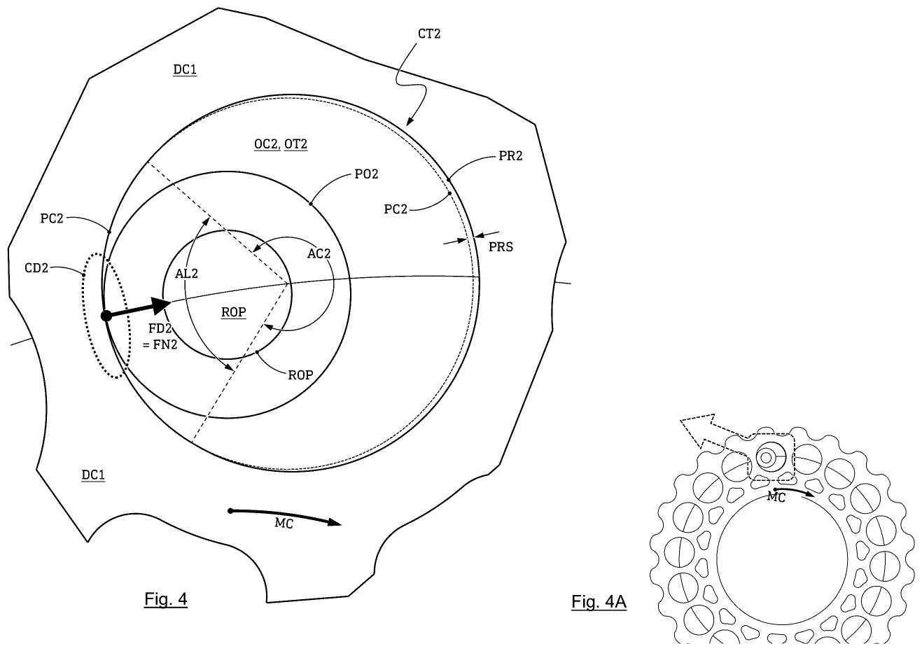

This can be seen in FIG. 3 and FIG. 4. FIG. 3 shows the relief contour PR1 in the area of the cycloidal tooth arrangement CT1, i.e. on the outer circumference of the cycloidal disc device DC1 as shown in FIG. 2, while FIG. 4 illustrates the relief contour PR2 in the area of the cycloidal tooth arrangement CT2, i.e. on the essentially cylindrical inner cycloidal profiles PC2.

It can be seen that the cycloidal profiles PC1, PC2 in those sub-areas AL1, AL2 of the respective profile PC1 and PC2 which, according to the above discussion with reference to FIG. 2, are mainly involved in the power transmission, correspond unchanged to the theoretical or respectively ideal profiles. On the other hand, the cycloidal profiles PC1, PC2 are slightly, but clearly recognizably, setback in the sub-areas AC1, AC2 of the respective profile PC1 and PC2, which is only slightly or not at all involved in the power transmission. As illustrated in FIG. 3, there may be a markedly setback relief contour PR1, particularly in the head areas of the wave-shaped toothing WCT of the outer profile of the cycloidal disc device CT1, since drive power is not actually transmitted in these areas in particular, as set forth above with reference to FIG. 2 and FIG. 2A.

Values for the setback dimension PRS of the relief contour PR1 are between 0.05 mm and 0.2 mm, preferably in the order of 0.1 mm, with an exemplary outer diameter of the housing tube TH of the cycloidal gear CG of 100 mm.

In this way, the stresses in the cycloidal gear CG discussed above are avoided or significantly reduced. The demands on the manufacturing accuracy of the cycloidal gear CG are also reduced, without this having any direct negative consequences in terms of the efficiency and service life of the cycloidal gear CG.

As a result, it is possible in accordance with the present disclosure to achieve a cycloidal gear CG which can be produced cost-effectively and which enables a high degree of efficiency in power transmission and simultaneously a long service life in a minimal installation space with minimal weight.

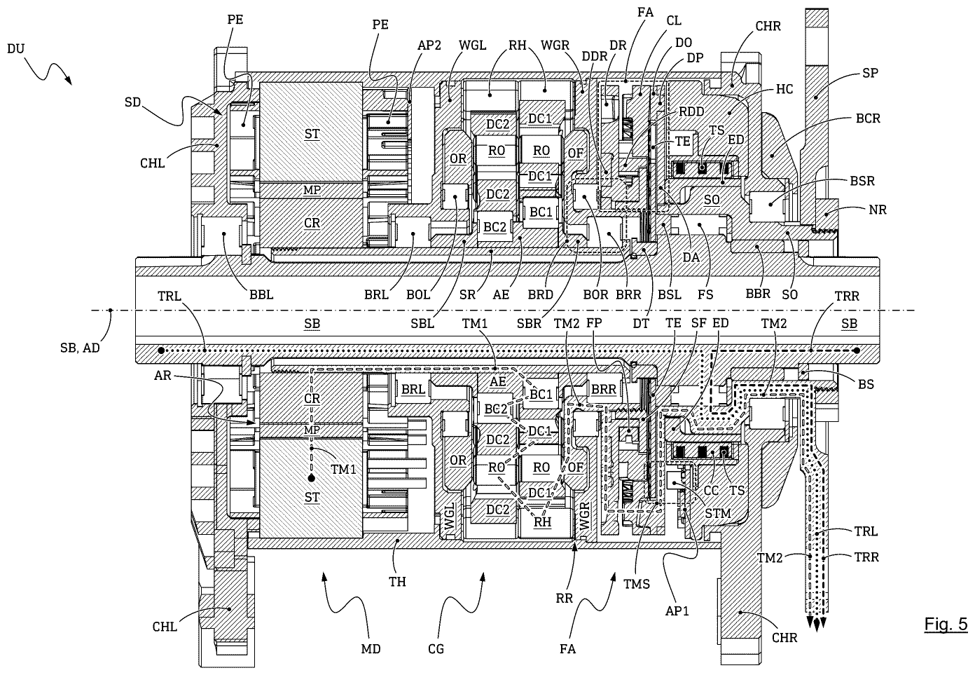

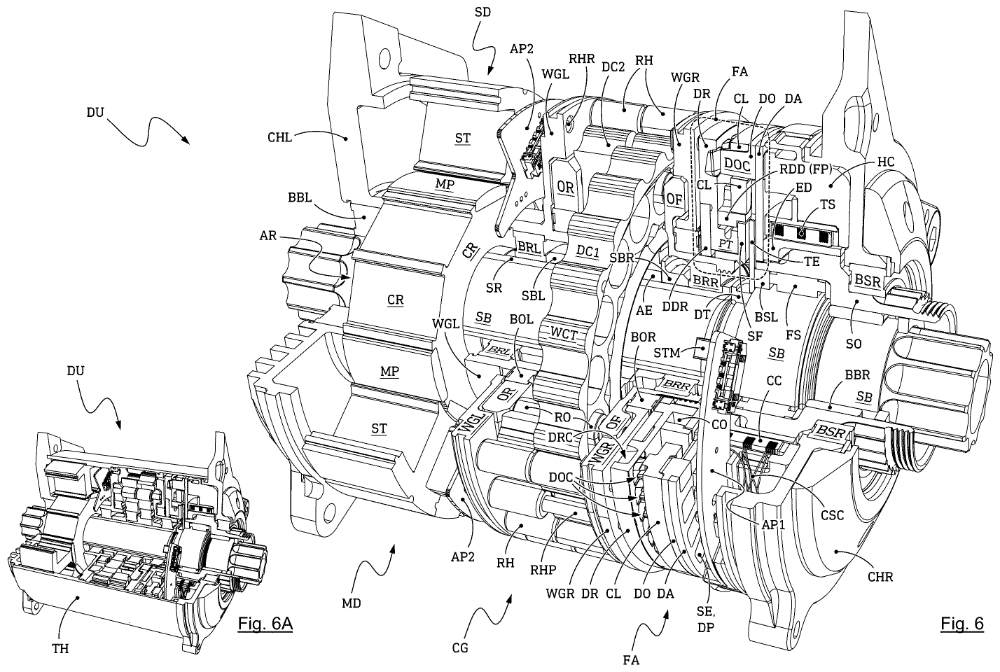

FIG. 5 shows an electric bicycle drive unit DU with a cycloidal gear CG according to FIGS. 2 to 4 in longitudinal section, while the drive unit DU in FIG. 6 (without housing tube TH) is shown in a partially sectioned oblique view.

FIG. 6A shows the drive unit with housing tube TH. A combined view of FIGS. 5 to 7 illustrates the main assemblies and components of the drive unit DU, including an electric motor device MD with a motor-rotor assembly AR and a motor-stator device SD, the cycloidal gear CG with two cycloidal disc devices DC1 and DC2, also an axial freewheel device FA, electronics assemblies AP1 and AP2 and a sensor arrangement with sensor devices and their sensor elements SSP, STM and TS.

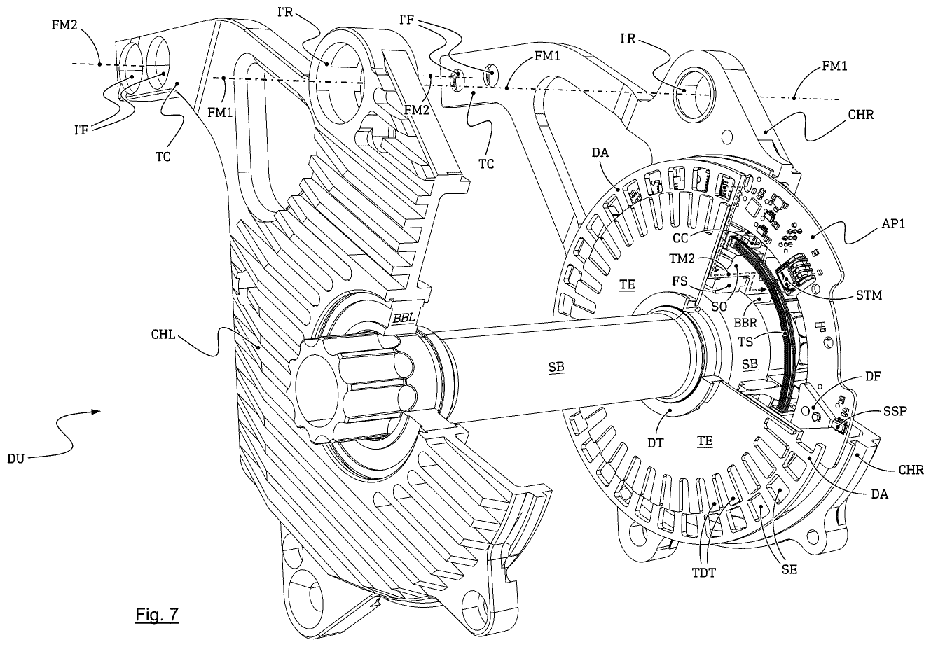

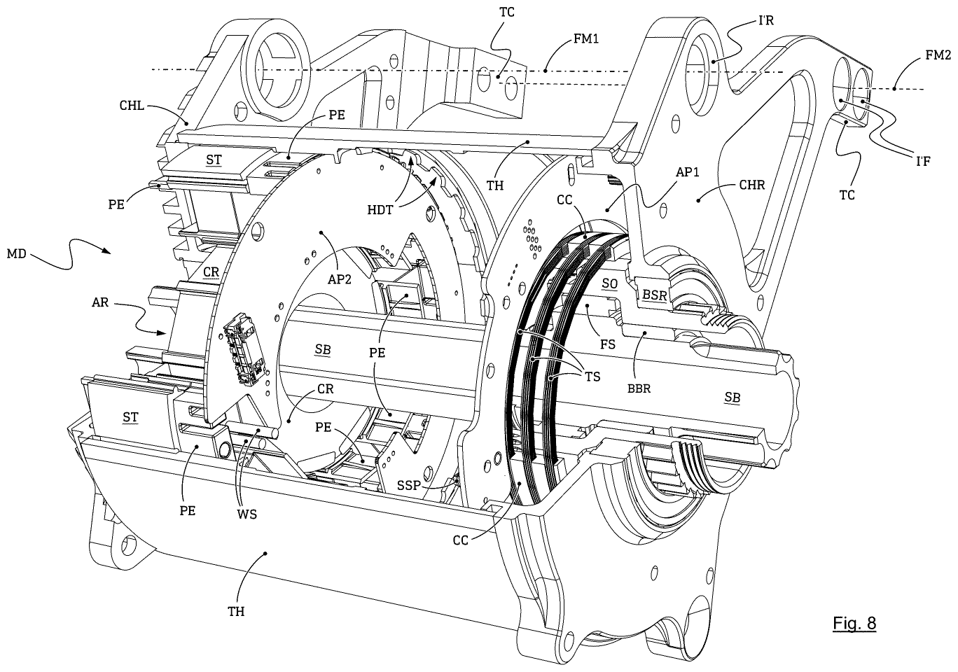

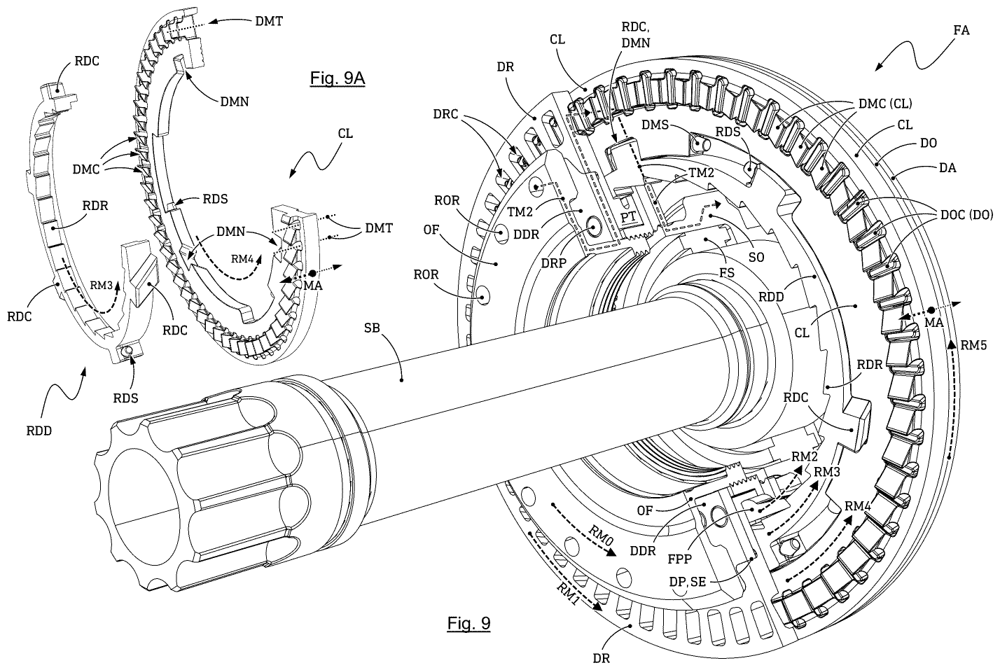

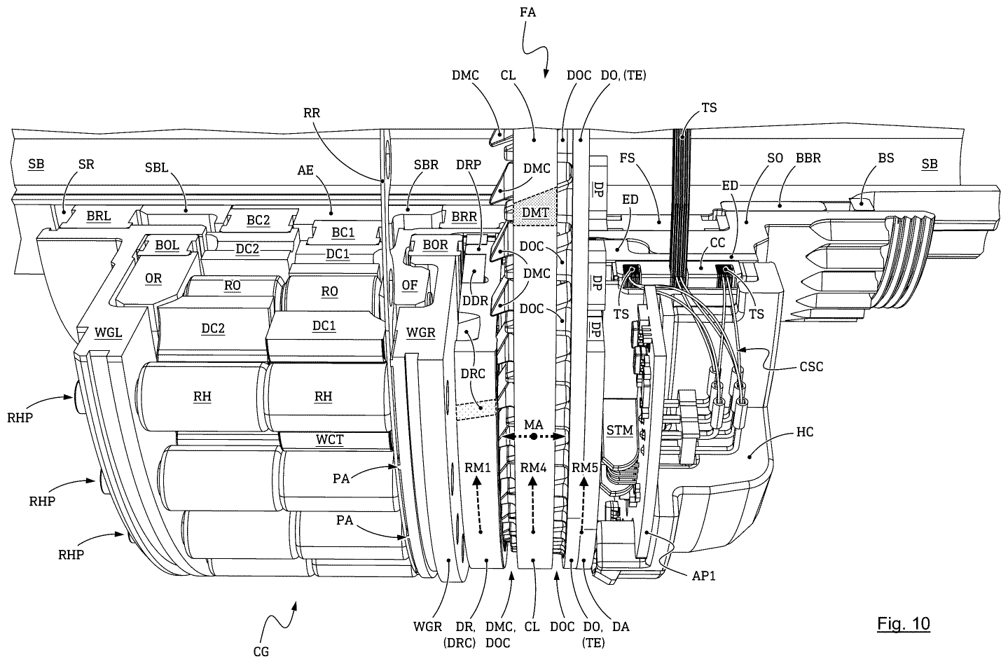

A combined view of FIG. 5 and FIG. 6 also illustrates the space-saving arrangement of the assemblies and components of the drive unit DU, which almost completely fill the installation space available within the housing TH, CHL, CHR. In particular, the axial freewheel device FA (see FIG. 6, FIGS. 9/9A and FIG. 10), the electronics assembly AP1 with the entire sensor electronics of all three sensor devices (see FIGS. 7 and 8) and the tachometer sensor device STM, TE (see FIG. 6 and FIG. 7) make significant contributions to this.

FIG. 5 and FIG. 6 also show a special shape of the cycloidal disc devices DC1 and DC2. The cycloidal disc devices are wider in the axial direction in the area of contact with the housing rollers RH than in the area of contact with the output rollers RO. This takes account of the fact that, due to the convex contact surfaces on both sides, there tends to be a higher surface pressure in the area of contact of the cycloidal disc devices with the housing rollers RH than in the area of contact of the cycloidal disc devices with the output rollers RO, where there is a concave-convex contact situation, as can be clearly seen in FIGS. 2 to 4. In order to compensate for the tendency towards higher surface pressure in the area of contact between the cycloidal disc devices and the housing rollers RH, the cycloidal disc devices are correspondingly wider on their outer circumference than in the radially more inner-lying area of contact with the output rollers RO. This is particularly advantageous if the cycloidal discs are made of light metal, for example of aluminium, which also has a lower hardness compared to steel in the contact areas CD1, CD2 with the opposing cycloidal devices OC1, OC2.

It should also be mentioned that other forms of internal toothing fixed to the housing can also be used in lieu of the housing rollers RH. Likewise, output pins or output ball bearings arranged on output pins can also be used in lieu of the output rollers RO, for example.

FIG. 5 also shows that the gear device CG is completely sealed off from the other assemblies of the drive unit DU by the two gearbox walls WGL and WGR and by the two rotor bearings BRL, BRR and the output bearings BOL, BOR, in particular sealed off at least in a liquid-tight manner. This enables an optimum and permanent supply of the gear device CG with the appropriate gear lubricant without the lubricant being able to escape from the gear device CG and impair the function of the other assemblies, in particular the motor device MD, the sensor devices and the electronics assemblies AP1 and AP2.

The complete separation of the gear device CG from the other assemblies of the drive unit DU is made possible in particular by the fact that the rotor shaft SR is mounted exclusively in the cycloidal gear CG, wherein the rotor assembly AR is arranged on the rotor shaft SR in the region of a flying end of the rotor shaft SR, and by the fact that the torque is discharged from the gear device CG by means of an output flange OF, which is mounted between the output bearing BOR and the right-hand rotor bearing BRR by means of a differential rotor bearing BRD.

Such a differential rotor bearing BRD with the arrangement of the rotor assembly AR on a flying end of the rotor shaft SR can in principle also be realized when using a cycloidal gear CG according to the prior art in a bicycle drive unit DU, and also when using other types of gears such as planetary gears, for example.

FIG. 5 also shows the main force flows TRL, TRR, TM1 and TM2 through the drive unit DU. TRL and TRR are the left-hand and right-hand rider torques TRL and TRR, respectively, which are introduced into the drive unit DU by the rider via the pedal cranks PD (see FIG. 1) and which are combined via a sprag body freewheel FS and introduced there in a radial direction from the bottom bracket shaft SB into the output shaft SO. At this point, it is then possible to measure the magnitude of the rider torque TRL, TRR by means of a deformation element ED without contact and, in particular, unaffected by the magnitude of the motor or gearbox torque TM2, which (in the axial area of the sprag body freewheel FS) is passed through the same cross-section of the output shaft SO as the rider torque.

The deformation element ED is in the form of a sleeve with a collar and consists of a magnetostrictively active alloy containing nickel or cobalt, for example. Depending on the magnitude of the rider torque TRL, TRR passed through the sprag body freewheel FS, the output shaft SO undergoes radial expansion in the area of the sprag body freewheel FS by means of the sprag body freewheel FS, which is communicated to the deformation element ED that is pressed onto the output shaft SO, for example. Due to the radial expansion of the deformation element ED, its magnetic or magnetostrictive properties change. This change can be detected without contact by means of a torque sensor TS (see also FIGS. 6 and 7 as well as FIGS. 8 and 10).

As can be seen from FIGS. 9/9A in conjunction with FIG. 6, the axial freewheel device FA is characterized in particular by the fact that the force flow coming from the gear device CG, i.e. the gearbox torque TM2, is guided through the axial freewheel device FA in the axial direction, relative to the bottom bracket shaft SB, by means of the coupling elements DR, CL and DO. The coupling elements DR, CL and DO are a ratchet disc DR, a claw ring CL, which can be moved displaceably axially along the direction MA, and an output claw disc DO.

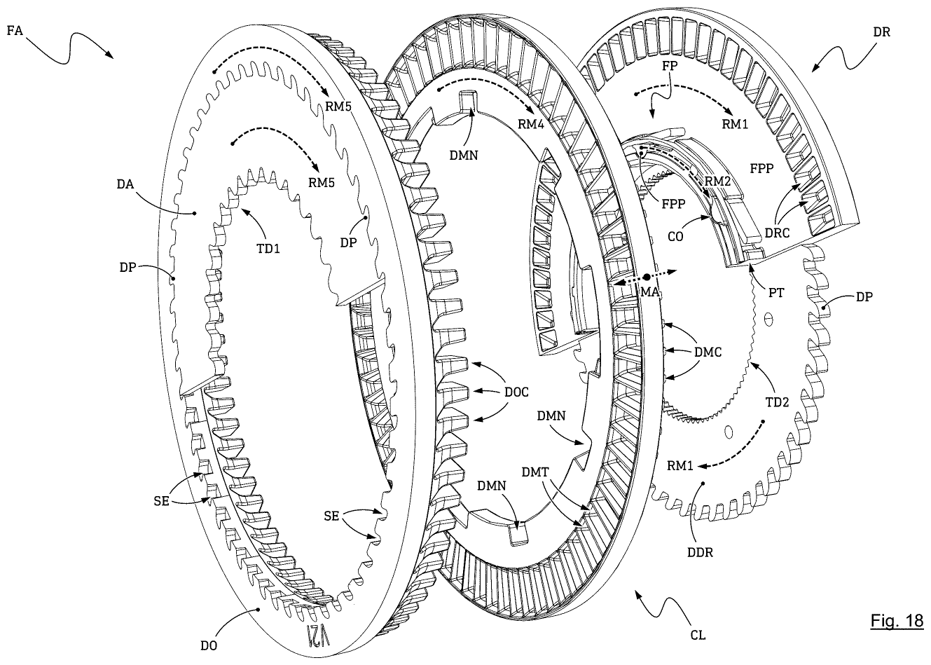

As in particular FIGS. 9/9A and FIG. 10 in conjunction with FIG. 5 and FIG. 18 show, the axial freewheel device FA is essentially flat in the shape of a disc, wherein the motor or gearbox torque TM2 is transmitted through the axial freewheel device FA in a radially far outer-lying area.

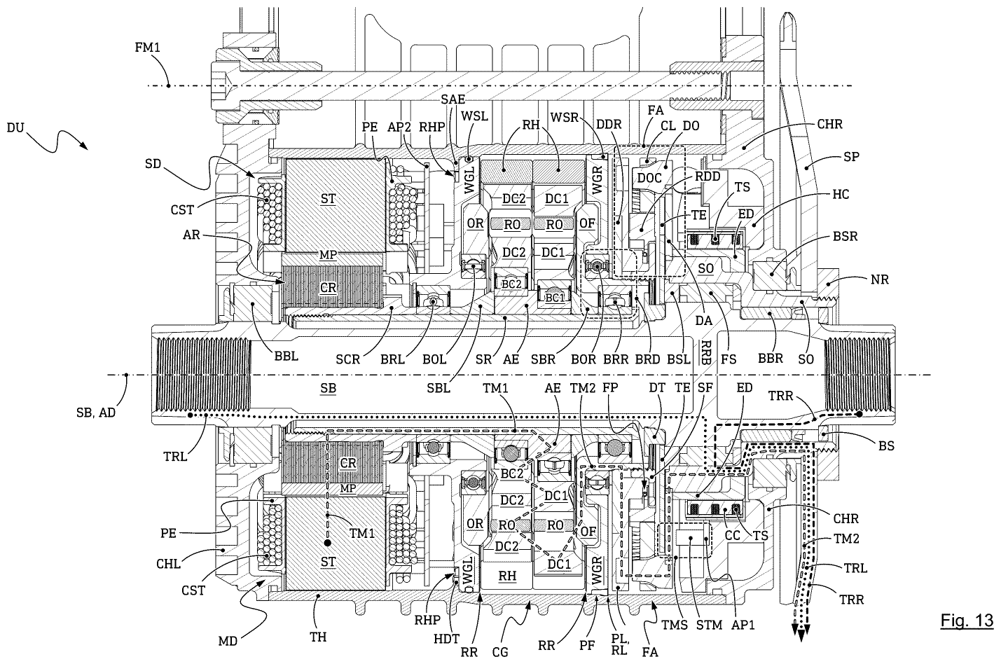

This is also illustrated once again by FIG. 18, which shows the output claw disc DO, claw ring CL and ratchet disc DR as well as the pawl-side components of a primary freewheel FP of the axial freewheel device FA. The illustration according to FIG. 18 is indeed derived from the further embodiment described further below according to FIGS. 13 to 21. However, the assemblies or components of the axial freewheel device FA that are shown in FIG. 18 correspond at least with regard to their functions with the axial freewheel device FA of the bicycle drive unit according to FIGS. 1 to 11.

FIG. 18 also shows in which way, in the further embodiment according to FIGS. 13 to 21, the metallic output disc DA of the axial freewheel device FA is connected to the output claw disc DO by means of driving protrusions DP and shape-corresponding engagement slots SE.

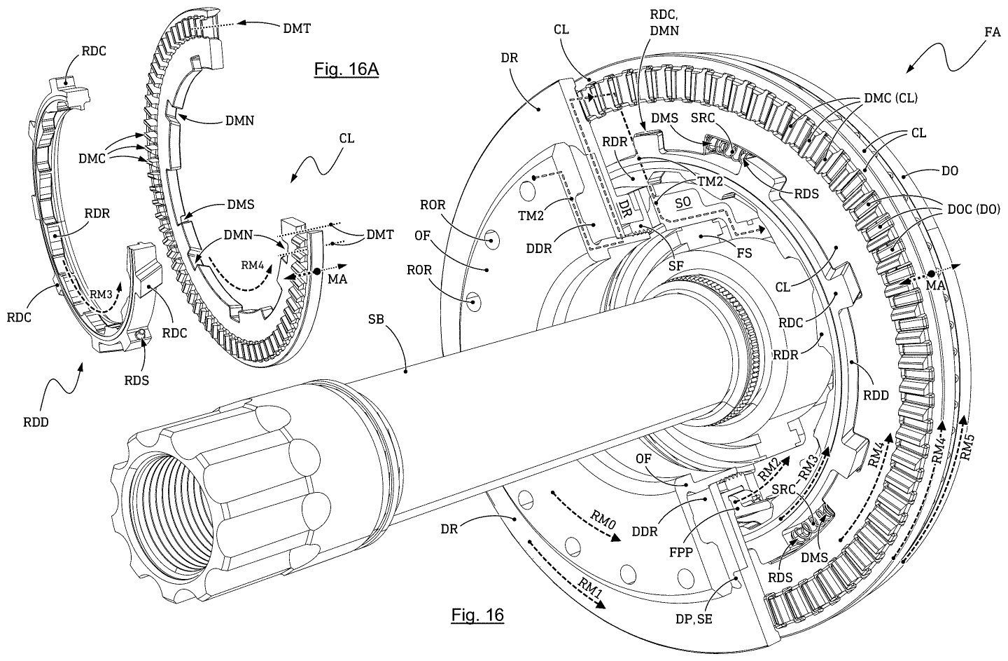

In a similar manner, the ratchet disc driver DDR is connected to the ratchet disc DR by means of driving protrusions DP and shape-corresponding engagement slots SE of the ratchet disc DR (not visible in FIG. 18, see, however, FIG. 9 or FIG. 16).

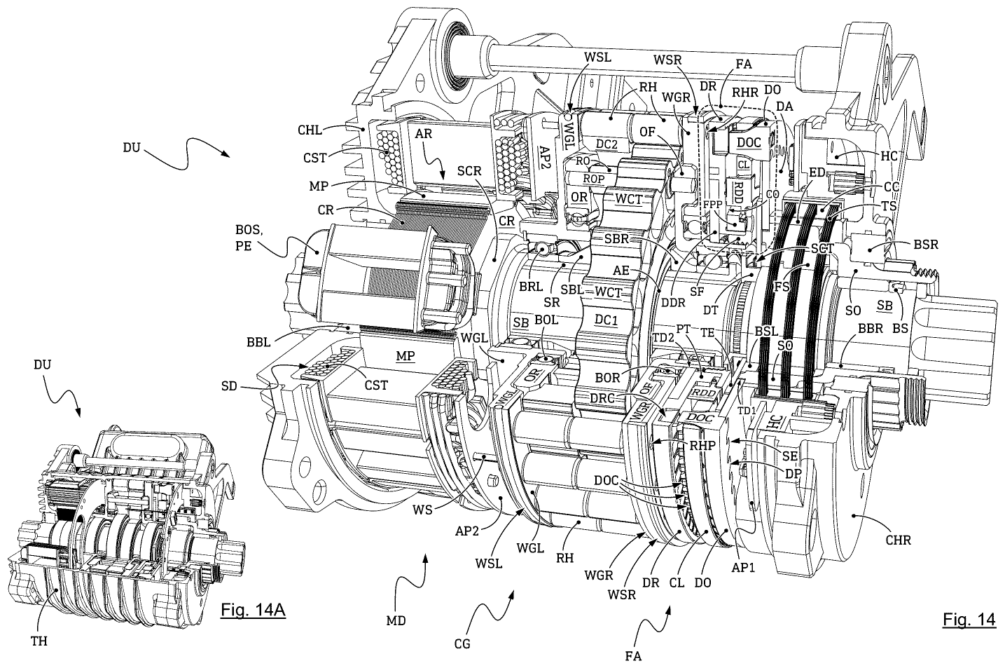

By means of the drive toothings TD1 and TD2 visible in FIG. 18, output disc DA is connected by output shaft SO or ratchet disc driver DDR to output flange OF of the gear device CG (see FIG. 14).

Due to the correspondingly large diameter of the freewheel tooth arrangement, which is formed by claws DMC and DOC as well as cutouts or holes DRC and DMT corresponding in shape, it is possible to arrange a multiplicity of corresponding claws DMC, DOC and cutouts or holes DRC, DMT on the correspondingly large circumference of the tooth arrangement DMC, DOC, DRC, DMT, which can be seen particularly clearly in FIGS. 9/9A. In addition, the large diameter of the tooth arrangement DMC, DOC, DRC, DMT results in reduced forces to be transmitted by the tooth arrangement DMC, DOC, DRC, DMT in accordance with the lever law with unchanged torque.

With this background, at least one of the coupling elements DR, CL, DO of the axial freewheel device FA, and at least one, multiple, or all of the coupling elements DR, CL, DO, consists essentially of a polymer material, in particular in the areas of the claws DMC and DOC, cutouts or holes DRC and DMT, i.e. in the area of the tooth arrangement DMC, DOC, DRC, DMT that is formed thereby. This allows particularly free shaping and very cost-effective production of the coupling elements DR, CL and DO. Furthermore, weight is saved in this way and the axial freewheel device FA is particularly quiet due to the elasticity and damping properties of the polymer material.

The axial freewheel device FA shown is also an actively controlled axial freewheel device in which the mutual engagement of the coupling elements DR, CL, DO is actively controlled depending on the direction of rotation by means of a control device RDD, RDC, DMN, FPP.

For this purpose, the axial freewheel device FA comprises a primary freewheel FP with a ratchet toothing RDR and with primary freewheel pawls FPP. The freewheel pawls FPP are pivotably arranged in corresponding collar recesses CO in a collar protrusion PT of the ratchet disc DR.

When the axial freewheel device FA is disengaged, the claw ring CL of the axial freewheel device FA, the claw ring CL being movable in the axial direction MA, is in an initial position on the right-hand side in relation to the figures (see FIGS. 5, 6 and 9).

In this initial position of the axially displaceable claw ring CL, the claws DMC of the claw ring CL do not engage in the associated cutouts DRC of the ratchet disc DR (see FIGS. 5, 6, 9 and 10), so that the output claw disc DO of the axial freewheel device FA, which is connected to the output shaft SO via the metallic output disc DA by means of driving protrusions DP of the output claw disc DO and shape-corresponding engagement slots SE of the output disc DA, can rotate freely together with the output shaft SO relative to the ratchet disc DR and thus relative to the gear device CG and motor device MD.

This free rotation of the output shaft SO relative to the gear device CG and motor device MD is virtually frictionless when the axial freewheel device FA is disengaged, since in this state only the low friction of the primary freewheel FP, FPP, which is configured solely so as to control the axial freewheel device FA, has to be overcome.

Thus, when the motor device MD is switched off, or when the rider accelerates beyond the assistance speed that is provided by the motor device MD, the bicycle has a natural and frictionless riding feel, since no components of the gear device or the motor device MD need to be rotated or held in place by the rider.

As soon as the motor device MD is put into operation, motor torque TM1 flows through the gear device CG and from this as gearbox torque TM2 through the output flange OF of the gear device CG via the metallic ratchet disc driver DDR into the ratchet disc DR and sets it in rotation (see FIGS. 5, 6 and 9). The primary freewheel pawls FPP (see FIG. 9), which are rotationally connected to the ratchet disc DR, then rotate the claw ring ratchet driver RDD (see FIGS. 9/9A) clockwise by means of its ratchet toothing RDR (in relation to the direction of view from the right as shown in FIG. 1). Due to the slant cams RDC of the ratchet driver RDD of the primary freewheel FP, which engage in corresponding slant grooves DMN of the claw ring CL (see FIGS. 9/9A), the claw ring CL is shifted to the left in the axial direction in the process.

This moment of axial displacement MA of the claw ring CL to the left in the direction of the ratchet disc DR, which is fixedly connected to the output flange OF of the cycloidal gear CG, is shown in FIG. 10. It can be seen that this brings the claws DMC of the claw ring CL into positive-locking engagement with the cutouts DRC of the ratchet disc DR. As a result, the motorized rotation of the ratchet disc DR is transmitted to the claw ring CL, and the latter is drawn closer to the ratchet disc DR due to the slant sawtooth shape of its claws DMC, which is also clearly visible in FIG. 10, in addition to the effect of the slant cams RDC of the ratchet driver RDD and the slant notches DMN of the claw ring CL (see FIGS. 9/9A), until the claw ring CL comes into full contact with the ratchet disc DR on the left-hand side.

In this relative position of the ratchet disc DR, claw ring CL and output claw disc DO, the motor or gearbox torque TM2 is then transmitted via the force flow path “output flange OF->ratchet disc driver DDR->ratchet disc DR->ratchet disc cutouts DRC->claw ring claws DMC->claw ring holes DMT->claw disc claws DOC->output claw disc DO->output disc DA” (see FIGS. 5, 6, 9 and 10) to the output shaft SO, where it combines with any rider torque TRL, TRR (see FIG. 5) in the axial area of the sprag body freewheel FS and from there is transferred via a chainwheel spider SP into the bicycle chain ring RC and thus into the power train TP (see combined view of FIG. 5, FIG. 9, FIG. 10 and FIG. 1). See also in this respect the rotational movements RM0 (output flange OF), RM1 (ratchet disc DR), RM2 (primary freewheel pawls FPP), RM3 (ratchet driver RDD), RM4 (claw ring CL) and RM5 (output claw disc DO) marked in FIGS. 9/9A.

If the motor torque TM1, TM2 ceases, or if the rider accelerates beyond the support speed provided by the motor device MD, the motor-side or transmission-side ratchet disc DR is overtaken by the rider-side or output-side claw disc DO. Since output claw disc DO and claw ring CL are rotationally coupled as closely as possible to each other owing to the positive penetration of the claw disc claws DOC through the claw ring holes DMT, the motor-side or transmission-side ratchet disc DR is therefore also overtaken by the claw ring CL. Owing to the claw ring claws DMC, which are chamfered on the non-load side, the claw ring CL is thereby displaced axially to the right (MA) in relation to the drawing and thus becomes disengaged from the ratchet disc DR.

The axial movement of the claw ring CL is also contributed to by the effect of the slant cams RDC of the ratchet driver RDD, which slant cams are spring-loaded by the claw ring return springs SRC in the slant notches DMN of the claw ring CL. After the claw ring CL is disengaged from the ratchet disc DR, the spring force of the claw ring return springs SRC leads, by means of the interaction of the slant cams RDC and the slant notches DMN, to the continuation of the movement MA of the claw ring CL to the right in relation to the drawing (see FIGS. 9, 10 and 18) until the claw ring CL comes to bear against the output claw disc DO (see FIGS. 5 and 6).

In this state according to FIGS. 5 and 6, the axial freewheel FA is completely disengaged, which is why it is then also completely silent, apart from a minimal noise of the primary freewheel FP, which only needs to be designed for generating the small forces required for the axial movement MA of the claw ring CL.

In principle, the axial freewheel device FA can also be implemented when using a cycloidal gear CG according to the prior art in a bicycle drive unit DU, and also when using other types of gears such as planetary gears. The axial freewheel device FA is also suitable for other applications in which an efficient, weight-saving and low-noise freewheel is required, see only by way of example for bicycle rear wheel hubs.

FIG. 7 shows, in particular in conjunction with FIG. 5, FIG. 6 and FIG. 10, the special arrangement of the disc-shaped tachometer element TE and the associated tachometer sensor element STM. The tachometer element TE is fixedly connected for conjoint rotation to the bottom bracket shaft SB by means of a tachometer driver DT (see FIGS. 5 to 7).

In particular, it can be seen in FIGS. 5 and 6 that the tachometer element TE is located inside the axial freewheel device FA, wherein the tachometer element TE and the associated tachometer sensor element STM are arranged on opposite sides of the output disc DA through which the gearbox torque TM2 flows and which can functionally be regarded as the wall of an area or section of the output shaft SO.

In other words, this means that the speed of the bottom bracket shaft SB is measured by detecting the speed of the tachometer element TE through the wall of an output shaft section provided with the output disc DA. For this purpose, the output disc DA is made of aluminium, while the tachometer element TE may be made of steel. In this way, the speed of the tachometer element TE, whose toothed shape TDT is clearly shown in FIG. 7, can be reliably measured, for example by means of a tachometer sensor element STM based on magnetic field detection, undisturbed by the presence of the output disc DA and undisturbed by any rotation thereof.

This special arrangement of the tachometer element TE within the axial freewheel device FA and on the side of the wall DA of an output shaft section through which the gearbox torque flows opposite the tachometer sensor element STM permits, on the one hand, the particularly space-saving arrangement of the assemblies of the drive unit DU, in particular the axial freewheel device FA, and, on the other hand, the combination of all three sensor devices: 1. tachometer sensor device TMS with tachometer sensor element STM, 2. torque sensor device with torque sensor element CC, TS and 3. speed sensor device with speed sensor element SSP of the drive unit DU in the area of a single electronics assembly AP1.

In particular, this means that essentially all electronic assemblies and electronic components of all three sensor devices can be arranged on a single circuit board device of the electronics assembly AP1, which saves on flying electrical connections and installation space, significantly increases the reliability of the sensor electronics and reduces the costs of manufacturing and assembling the drive unit DU.

The special arrangement of the tachometer element TE within the axial freewheel device FA and on the side of the wall DA of an output shaft section through which the gearbox torque flows opposite the tachometer sensor element STM can, in principle, also be realized when using a cycloidal gear CG according to the prior art in a bicycle drive unit DU, and also when using other types of gears such as planetary gears.

The speed sensor element SSP can be seen in FIG. 7 and FIG. 8. The speed sensor element SSP is used to determine the speed of the rear wheel WB of the bicycle (see FIG. 1) by means of a magnet that is arranged in the area of the rim of the wheel WB or, for example, on an air valve of the rear wheel WB. The integration of the speed sensor element SSP into the drive unit DU eliminates the need for additional flying cables on the bicycle frame and the associated assembly work as well as the associated sources of error during operation of the bicycle. FIG. 7 shows that a magnetic flux director DF is arranged adjacent to the speed sensor element SSP. This increases the sensitivity of the speed sensor element SSP and thus the reliability of determining the speed of the bicycle.

FIG. 10 also shows a spacer element that may be made of spring steel, in the form of a roller thrust ring RR, which is arranged between the housing rollers RH and the right-hand gearbox wall WGR. Since the housing rollers RH have a slight tendency to move to the right in the drawing against the gearbox wall WGR when the motor torque TM1 is applied, among other things due to slight elastic-rotational torsion of the cycloidal gear CG, the roller thrust ring RR protects the gearbox wall WGR, that may be made of aluminium, from wear and, in particular, from chip formation that is harmful to the gear.

In order to enclose the housing rollers RH between the gearbox walls WGL and WGR with as little play as possible, the roller thrust ring RR does not lie flat against the right-hand gearbox wall WGR, but is supported by web-shaped axial protrusions PA on the gearbox wall WGR, which run in the radial direction and are located between the housing rollers RH in the circumferential direction at an angle, in such a way that an elastically resilient pre-stressing acting on the housing rollers RH in the axial direction is created.

FIG. 8 again shows the electronics assembly AP1, which comprises a circuit board which is in the shape of a circular-ring segment and on which all electronic assemblies and electronic components of all three sensor devices are arranged. Also visible in FIG. 8 is a further electronics assembly AP2, whose circuit board is also in the shape of a circular-ring segment. The circuit board of the electronics assembly AP2 can in particular carry all the electronic assemblies and electronic components that are required to directly control the motor device MD, also for example the power electronics required for this.

In addition, FIG. 8 shows torque recesses HDT arranged in the housing tube TH. Axially projecting ends of the housing roller pins RHP engage in the torque recesses HDT on the left-hand side. (see FIG. 10). In this way, the torque that is to be supported via the housing rollers RH can be introduced into the housing tube TH by the shortest route.

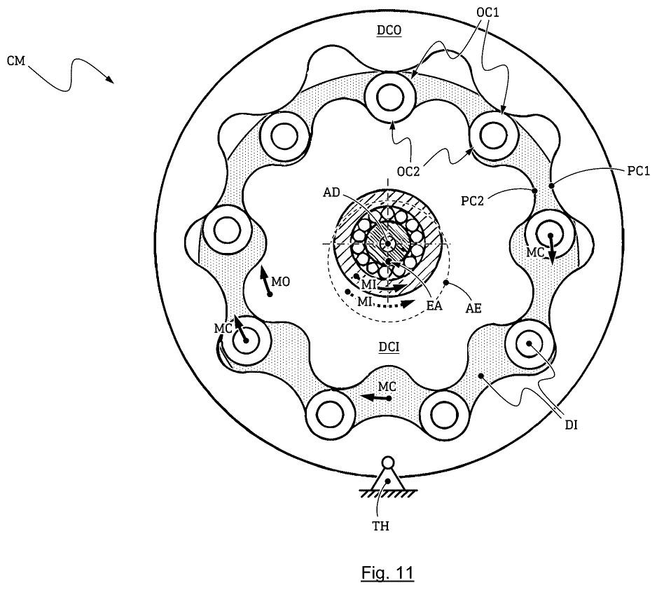

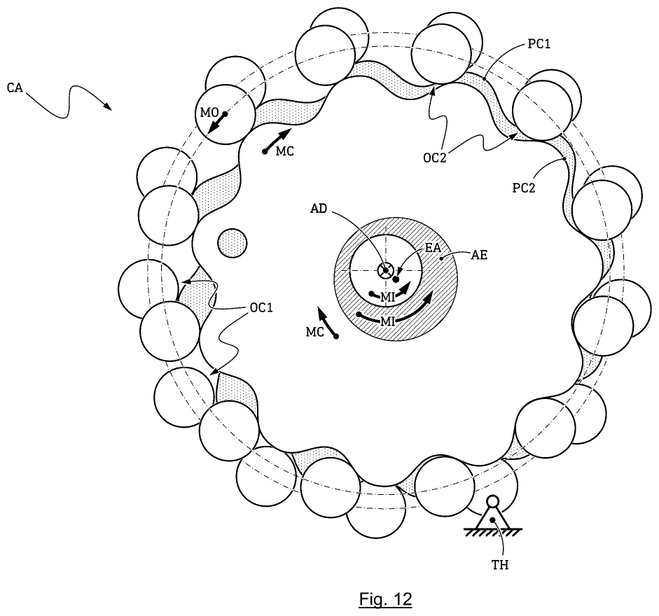

FIG. 11 shows a cycloidal gear CM known as a “compur gear”, and FIG. 12 shows another cycloidal gear CA known as a “Cyclo-Acbar gear”. The entire teaching according to the present disclosure is also applicable to these types of cycloidal gears.

FIGS. 13 to 21 show a further embodiment of a cycloidal gear CG or a further embodiment of a bicycle drive unit DU, respectively, wherein the illustrations according to FIGS. 13 to 21 essentially correspond to the illustrations according to FIGS. 5 to 7 and 9 to 11.

Cycloidal gear CG and drive unit DU according to FIGS. 13 to 21 largely correspond to cycloidal gear CG and drive unit DU according to FIGS. 5 to 7 and 9 to 11 in terms of function and arrangement of the assemblies and components contained therein, but are optimized in terms of function and refined in terms of design compared to the latter. Although FIG. 8 shows the first embodiment of the bicycle drive unit DU according to FIGS. 1 to 10, the basic properties and functions of the components and assemblies described with regard to FIG. 8 also apply mutatis mutandis to the further embodiment of the bicycle drive unit DU according to FIGS. 13 to 21.

The following description of the further embodiment, within the scope of the description of FIGS. 13 to 17, largely corresponds to the description of the above embodiment according to FIGS. 5 to 7 and 9 to 11. In the following description of the further embodiment, within the scope of the description of FIGS. 13 to 17, mainly the numbers of the figures to which the description refers have been changed from FIGS. 5 to 7 and 9 to 11 to FIGS. 13 to 17.

If, in the further embodiment according to FIGS. 13 to 21, assemblies or components have been added or substantially changed compared to the above embodiment according to FIGS. 5 to 7 and 9 to 11, this is pointed out in the following description.

FIG. 13 shows another embodiment of an electric bicycle drive unit DU with a cycloidal gear CG according to FIGS. 2 to 4 in longitudinal section, while the drive unit DU in FIG. 14 (without housing tube TH) is shown in a partially sectioned oblique view.

FIG. 14A shows the drive unit with housing tube TH.

A combined view of FIGS. 13 to 15 illustrates the main assemblies and components of the drive unit DU, including an electric motor device MD with a motor-rotor assembly AR and a motor-stator device SD, the cycloidal gear CG with two cycloidal disc devices DC1 and DC2, also an axial freewheel device FA, electronics assemblies AP1 and AP2 and a sensor arrangement with sensor devices and their sensor elements SSP, STM and TS.

The motor-rotor assembly AR comprises, in particular, a rotor core CR, for example comprising a rotor laminated core as shown in FIGS. 13 and 14, and permanent magnets MP, which are held by the rotor core CR in a form-fitting manner, for example (see also FIGS. 5, 6 and 8).

The stator device SD comprises, in particular, stator end plates PE, which in the embodiment according to FIGS. 13 to 21 are composed of a number of stator bobbins BOS (see FIG. 14), each of which carries a stator coil CST with stator connecting wires WS on its outer circumference and each of which accommodates a stator tooth ST in its interior (not shown in FIG. 14, but cf. FIGS. 5, 6, 8 and 13).

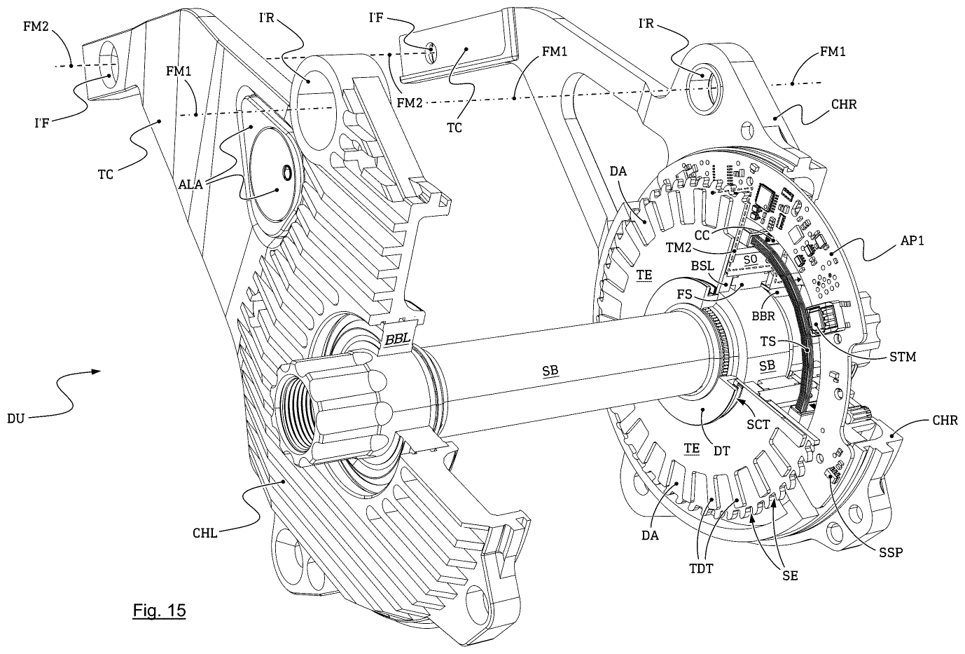

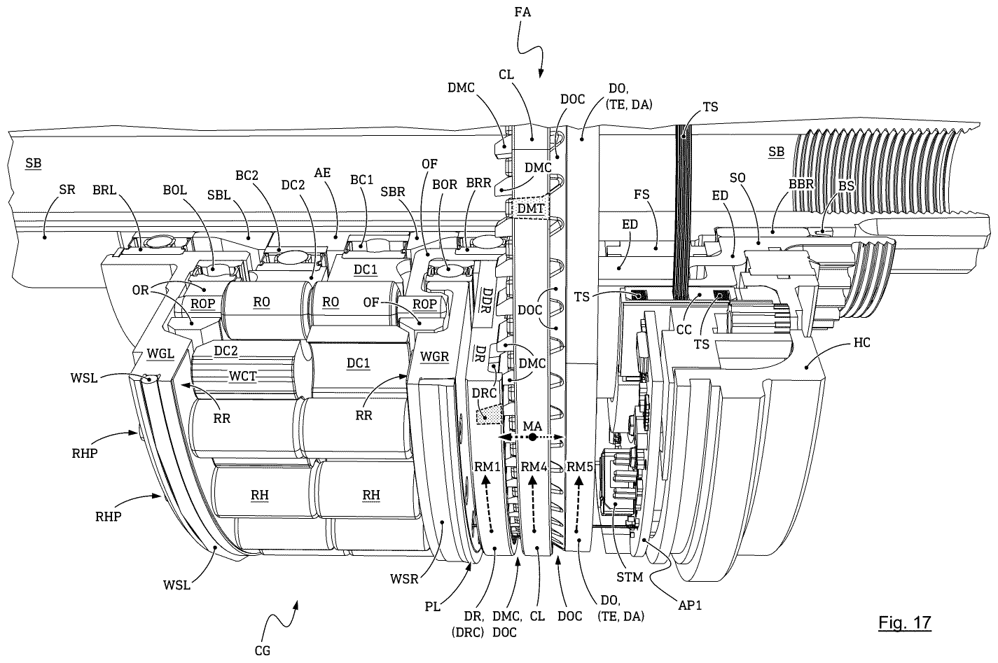

A combined view of FIG. 13 and FIG. 14 also illustrates the space-saving arrangement of the assemblies and components of the drive unit DU, which almost completely fill the installation space available within the housing TH, CHL, CHR. In particular, the axial freewheel device FA (see FIG. 14, FIGS. 16/16A, FIGS. 17 and 18), the electronics assembly AP1 with the entire sensor electronics of all three sensor devices (see FIGS. 8 and 15) and the tachometer sensor device STM, TE (see FIG. 14 and FIG. 15) make significant contributions to this.

FIG. 13 and FIG. 14 also show a special shape of the cycloidal disc devices DC1 and DC2. The cycloidal disc devices are wider in the axial direction in the area of contact with the housing rollers RH than in the area of contact with the output rollers RO. This takes account of the fact that, due to the convex contact surfaces on both sides, there tends to be a higher surface pressure in the area of contact of the cycloidal disc devices with the housing rollers RH than in the area of contact of the cycloidal disc devices with the output rollers RO, where there is a concave-convex contact situation, as can be clearly seen in FIGS. 2 to 4. In order to compensate for the tendency towards higher surface pressure in the area of contact between the cycloidal disc devices and the housing rollers RH, the cycloidal disc devices are correspondingly wider on their outer circumference than in the radially more inner-lying area of contact with the output rollers RO. This is particularly advantageous if the cycloidal discs are made of light metal, for example of aluminium, which also has a lower hardness compared to steel in the contact areas CD1, CD2 with the opposing cycloidal devices OC1, OC2.

It should also be mentioned that other forms of internal toothing fixed to the housing can also be used in lieu of the housing rollers RH. Likewise, output pins or output ball bearings arranged on output pins can also be used in lieu of the output rollers RO, for example.

FIG. 13 also shows that the gear device CG is completely sealed off from the other assemblies of the drive unit DU by the two gearbox walls WGL and WGR and by the two rotor bearings BRL, BRR and the output bearings BOL, BOR, in particular sealed off at least in a liquid-tight manner. This enables an optimum and permanent supply of the gear device CG with the appropriate gear lubricant without the lubricant being able to escape from the gear device CG and impair the function of the other assemblies, in particular the motor device MD, the sensor devices and the electronics assemblies AP1 and AP2.

Owing to the at least liquid-tight closure of the gear device CG, low-viscosity fluid or at least relatively low-viscosity or gel-like lubricant can advantageously be used for lubricating the gear device, which allows better distribution of the lubricant and thus more thorough lubrication, while at the same time allowing better cooling of the rolling surfaces of the cycloidal gear CG compared to conventional, highly viscous lubricants, such as grease.

The complete sealing of the gear device CG from the other assemblies of the drive unit DU is made possible in particular by the fact that the rotor shaft SR is mounted exclusively in the cycloidal gear CG, wherein the rotor assembly AR is arranged on the rotor shaft SR in the region of a flying end of the rotor shaft SR (on the left in relation to the drawing in FIGS. 5 to 10 and FIGS. 13 to 17), and by the fact that the torque is discharged from the gear device CG by means of an output flange OF, which is mounted between the output bearing BOR and the right rotor bearing BRR by means of a differential rotor bearing BRD.

Together with output flange OF, an opposing ring OR, rotatably supported on the left-side gearbox wall WGL by means of output bearing BOL, supports and guides the output roller axles ROP with regard to the rotating motion of the output roller axles ROP and the output rollers RO, around the center axis AD of the cycloidal gear CG (see FIGS. 5, 6, 10, 13, 14 and 17).

Such a differential rotor bearing BRD with the arrangement of the rotor assembly AR on a flying end of the rotor shaft SR can in principle also be realized when using a cycloidal gear CG according to the prior art in a bicycle drive unit DU, and also when using other types of gears such as planetary gears, for example.

In combined view with FIGS. 14/14A and 17, FIG. 13 also shows the arrangement and fastening of the cycloidal gear CG in the housing tube TH. It can be seen that the left-hand gearbox wall WGL is pushed, or pressed, respectively, into the housing tube TH from the right-hand side up to an axial stop SAE. The right-hand gearbox wall WGR is also pushed, or pressed, respectively, into the housing tube TH from the right.

The right-hand gearbox wall WGR is secured by a right-hand gearbox seal WSR, the shape of which is clearly visible in FIGS. 14 and 17. When the right-hand gearbox wall WGR is pressed into the housing tube TH, the right-hand gearbox seal WSR forms a press fit PF (see FIG. 13) between the right-hand gearbox wall WGR and the housing tube TH. At the same time, the right-hand gearbox seal WSR forms a snap-in fastening between the gearbox wall WGR and the housing tube TH. This is achieved by means of a circumferential latching projection PL on the right-hand gearbox seal WSR, which engages in a shape-corresponding circumferential latching recess RL inside the housing tube TH, thus preventing unwanted migration of the right-hand gearbox wall WGR to the right out of the housing tube TH.

Left-hand and right-hand gearbox seal WSL, WSR and the associated geometries on the inner circumference of the housing tube TH and on the outer circumferences of the left-hand and right-hand gearbox walls WGL, WGR can be shaped in such a way that there is no direct metallic contact between the left-hand or right-hand gearbox wall WGL or WGR and the inner surface of the housing tube TH. This way, effective damping of vibrations and noise generated in the cycloidal gearbox can be achieved.

The bearing spacers SBL, SBR (see also FIGS. 5, 6, 10, 14 and 17), which can be seen in FIG. 13, enable a closed force flow through rotor shaft SR, rotor carrier sleeve SCR (see FIG. 14), left rotor bearing BRL, left bearing spacer SBL, cam arrangement AE, right bearing spacer SBR, right rotor bearing BRR and from there back onto the rotor shaft SR. In this way, these components which are mentioned are axially clamped against each other and, owing to the resulting frictional forces, are also rotationally fixedly connected to each other.

With reference to the cycloidal gear CG according to FIG. 2 and the associated description, the components rotor shaft SR and eccentric arrangement AE as shown in FIG. 13 together form the drive shaft device DSD (see also FIGS. 5, 6 and 14).

FIG. 13 also shows the main force flows TRL, TRR, TM1 and TM2 through the drive unit DU. TRL and TRR are the left-hand and right-hand rider torques TRL and TRR, respectively, which are introduced into the drive unit DU by the rider via the pedal cranks PD (see FIG. 1) and which are combined via a sprag body freewheel FS and introduced there in a radial direction from the bottom bracket shaft SB into the output shaft SO.

At this point, it is then possible to measure the magnitude of the rider torque TRL, TRR by means of a deformation element ED without contact and, in particular, unaffected by the magnitude of the motor or gearbox torque TM2, which (in the axial area of the sprag body freewheel FS) is passed through the same cross-section of the output shaft SO as the rider torque.

The deformation element ED is in the form of a sleeve with a collar and consists of a magnetostrictively active alloy containing nickel or cobalt, for example. Depending on the magnitude of the rider torque TRL, TRR passed through the sprag body freewheel FS, the output shaft SO undergoes radial expansion in the area of the sprag body freewheel FS by means of the sprag body freewheel FS, which is communicated to the deformation element ED that is pressed onto the output shaft SO, for example. Due to the radial expansion of the deformation element ED, its magnetic or magnetostrictive properties change. This change can be detected by means of a torque sensor TS (see also FIGS. 8, 14, 15 and 17) without contact.

To further improve the accuracy of the determination of the rider torque TRL, TRR by measuring the radial expansion of the sprag body freewheel FS and deformation element ED by means of the torque sensor TS, the bottom bracket shaft SB has a radial reinforcement bridge RRB in the embodiment according to FIGS. 13 to 21. The radial reinforcement bridge RRB prevents the wall of the bottom bracket shaft SB in the area of the sprag body freewheel FS from deforming radially inwards when subjected to rider torques TRL, TRR, and also enables the wall thicknesses of the bottom bracket shaft SB to be reduced, thus saving material and weight.

As can be seen from FIGS. 16/16A in conjunction with FIGS. 13, 14, 17 and 18, the axial freewheel device FA is characterized in particular by the fact that the force flow coming from the transmission device CG, via the output rollers RO and output roller pins ROP (see FIGS. 2, 5, 6, 9, 13, 14 and 17) and output roller pin receptacles ROR (see FIGS. 9 and 16), i.e the gearbox torque TM2, is guided through the axial freewheel device FA in the axial direction, relative to the bottom bracket shaft SB, by means of the coupling elements DR, CL and DO. The coupling elements DR, CL and DO are a ratchet disc DR, a claw ring CL, which can be moved displaceably axially along the direction MA, and an output claw disc DO.

As in particular FIG. 16 and FIG. 17 in conjunction with FIG. 13 show, the axial freewheel device FA is essentially flat in the shape of a disc, wherein the motor or gearbox torque TM2 is transmitted through the axial freewheel device FA in a radially far outer-lying area.

Due to the correspondingly large diameter of the freewheel tooth arrangement, which is formed by claws DMC and DOC as well as cutouts or holes DRC and DMT corresponding in shape, it is possible to arrange a multiplicity of corresponding claws DMC, DOC and cutouts or holes DRC, DMT on the correspondingly large circumference of the tooth arrangement DMC, DOC, DRC, DMT, which can be seen particularly clearly in FIG. 16. In addition, the large diameter of the tooth arrangement DMC, DOC, DRC, DMT results in reduced forces to be transmitted by the tooth arrangement DMC, DOC, DRC, DMT in accordance with the lever law with unchanged torque.

With this background, at least one of the coupling elements DR, CL, DO of the axial freewheel device FA, and one, multiple, or all of the coupling elements DR, CL, DO, consists essentially of a polymer material, in particular in the areas of the claws DMC and DOC, cutouts or holes DRC and DMT, i.e. in the area of the tooth arrangement DMC, DOC, DRC, DMT that is formed thereby. This allows particularly free shaping and cost-effective production of the coupling elements DR, CL and DO. Furthermore, weight is saved in this way and the axial freewheel device FA is quiet due to the elasticity and damping properties of the polymer material.

The axial freewheel device FA shown is also an actively controlled axial freewheel device in which the mutual engagement of the coupling elements DR, CL, DO is actively controlled depending on the direction of rotation by means of a control device RDD, RDC, DMN, FPP.

For this purpose, the axial freewheel device FA comprises a primary freewheel FP with a ratchet toothing RDR and with primary freewheel pawls FPP. The freewheel pawls FPP are pivotably arranged in corresponding collar recesses CO in a collar protrusion PT of the ratchet disc DR.

When the axial freewheel device FA is disengaged, the claw ring CL of the axial freewheel device FA, the claw ring CL being movable in the axial direction MA, is in an initial position on the right-hand side in relation to the figures (see FIGS. 13, 14 and 16).

In this initial position of the axially displaceable claw ring CL, the claws DMC of the claw ring CL do not engage in the associated cutouts DRC of the ratchet disc DR (see FIGS. 13, 14 and 16 to 18), so that the output claw disc DO of the axial freewheel device FA, which is connected to the output shaft SO via the metallic output disc DA by means of driving protrusions DP of the output claw disc DO and shape-corresponding engagement slots SE of the output disc DA, can rotate freely together with the output shaft SO relative to the ratchet disc DR and thus relative to the gear device CG and motor device MD.

This free rotation of the output shaft SO relative to the gear device CG and motor device MD is virtually frictionless when the axial freewheel device FA is disengaged, since in this state only the low friction of the primary freewheel FP, FPP, which is configured solely so as to control the axial freewheel device FA, has to be overcome.

Thus, when the motor device MD is switched off, or when the rider accelerates beyond the assistance speed that is provided by the motor device MD, the bicycle has a natural and frictionless riding feel, since no components of the gear device or the motor device MD need to be rotated or held in place by the rider.

As soon as the motor device MD is put into operation, motor torque TM1 flows through the gear device CG and from this as gearbox torque TM2 through the output flange OF of the gear device CG via the metallic ratchet disc driver DDR into the ratchet disc DR and sets it in rotation (see FIGS. 13, 14 and 16 to 18). The visualization of the force flow of the motor torque TM1 as a zigzag line through gear CG in FIG. 13 and FIG. 5 is only to be understood as a symbolic simplification of the actual force flow. The actual force flow through the gear CG is shown in FIGS. 2 to 4A and explained in detail in the corresponding description of the figures.

The primary freewheel pawls FPP (see FIGS. 16 and 18), which are rotationally connected to the ratchet disc DR, then rotate the claw ring ratchet driver RDD (see FIGS. 16/16A) clockwise by means of its ratchet toothing RDR (in relation to the direction of view from the right as shown in FIG. 1).

Due to the slant cams RDC of the ratchet driver RDD of the primary freewheel FP, which engage in corresponding slant grooves DMN of the claw ring CL (see FIGS. 16/16A), the claw ring CL is shifted to the left in the axial direction in the process.

This moment of axial displacement MA of the claw ring CL to the left in the direction of the ratchet disc DR, which is fixedly connected to the output flange OF of the cycloidal gear CG, is shown in FIG. 17. It can be seen that this brings the claws DMC of the claw ring CL into positive-locking engagement with the cutouts DRC of the ratchet disc DR. As a result, the motorized rotation of the ratchet disc DR is transmitted to the claw ring CL, and the latter is drawn closer to the ratchet disc DR due to the slant sawtooth shape of its claws DMC, which is also visible in FIG. 17, in addition to the effect of the slant cams RDC of the ratchet driver RDD and the slant notches DMN of the claw ring CL (see FIGS. 16/16A), until the claw ring CL comes into full contact with the ratchet disc DR on the left-hand side.

In this relative position of the ratchet disc DR, claw ring CL and output claw disc DO, the motor or gearbox torque TM2 is then transmitted via the force flow path “output flange OF->ratchet disc driver DDR->ratchet disc DR->ratchet disc cutouts DRC->claw ring claws DMC->claw ring holes DMT->claw disc claws DOC->output claw disc DO->output disc DA” (see FIGS. 13, 14, 16 and 17) to the output shaft SO, where it combines with any rider torque TRL, TRR (see FIG. 13) in the axial area of the sprag body freewheel FS and from there is transferred via a chainwheel spider SP into the bicycle chain ring RC and thus into the power train TP (see combined view of FIG. 13, FIG. 16, FIG. 17 and FIG. 1). See also in this respect the rotational movements RM0 (output flange OF), RM1 (ratchet disc DR), RM2 (primary freewheel pawls FPP), RM3 (ratchet driver RDD), RM4 (claw ring CL) and RM5 (output claw disc DO) marked in FIGS. 16/16A.

The axial freewheel device FA according to FIGS. 16 to 18 of the further embodiment of a bicycle drive unit DU according to FIGS. 1 to 4 and 13 to 21 differs from the axial freewheel device FA according to FIGS. 16 and 17 of the first embodiment of a bicycle drive unit DU according to FIGS. 1 to 10, in addition to various structural refinements, in particular by a more fine-toothed design of the respective teeth of the ratchet disc DR, claw ring CL and output claw disc DO. Owing to this more fine-toothed design, the axial freewheel device FA can either transmit higher torques or lower loads per claw DMC, DOC or per claw ring through hole DMT and ratchet disc cutout DRC.

Corresponding combined views of FIG. 17 and FIG. 10 and of FIG. 16 and FIG. 9 also illustrate the different tooth shapes of the claws DMC or DOC of claw ring CL or output claw disc DO, respectively, between first and further embodiment, and the different geometries of the claw ring through holes DMT and ratchet disc cutouts DRC.

In addition to the above-mentioned more fine-toothed design in the further embodiment of the axial freewheel device FA according to FIGS. 16 and 17, claws DMC and DOC and through holes and cutouts DMT and DRC in this embodiment are less wedge-shaped and less inclined in the direction of rotation RM0 to RM5, which supports an even more reliable shifting behaviour of the axial freewheel device FA in all riding situations and torque loadings that occur in practice.

The claw ring ratchet driver RDD with the primary freewheel FP arranged in its radial interior, in particular its ratchet toothing RDR, also differs between the first and the further embodiment (see FIGS. 9/9A and FIGS. 16/6A). The further embodiment according to FIGS. 16/6A is optimized in particular with regard to reliability, torque transmission, noise generation and rigidity of the ratchet toothing RDR and the primary freewheel pawls FPP.

If the motor torque TM1, TM2 ceases, or if the rider accelerates beyond the support speed provided by the motor device MD, the motor-side or transmission-side ratchet disc DR is overtaken by the rider-side or output-side claw disc DO. Since output claw disc DO and claw ring CL are rotationally coupled as closely as possible to each other owing to the positive penetration of the claw disc claws DOC through the claw ring holes DMT, the motor-side or transmission-side ratchet disc DR is therefore also overtaken by the claw ring CL. Owing to the claw ring claws DMC, which are chamfered on the non-load side, the claw ring CL is thereby displaced axially to the right (MA) in relation to the drawing and thus becomes disengaged from the ratchet disc DR.

The axial movement of the claw ring CL is also contributed to by the effect of the slant cams RDC of the ratchet driver RDD, which slant cams are spring-loaded by the claw ring return springs SRC in the slant notches DMN of the claw ring CL. After the claw ring CL is disengaged from the ratchet disc DR, the spring force of the claw ring return springs SRC leads, by means of the interaction of the slant cams RDC and the slant notches DMN, to the continuation of the movement MA of the claw ring CL to the right in relation to the drawing (see FIGS. 16 to 18) until the claw ring CL comes to bear against the output claw disc DO (see FIGS. 13 and 14).

In this state according to FIGS. 13 and 14, the axial freewheel FA is completely disengaged, which is why it is then also completely silent, apart from a minimal noise of the primary freewheel FP, which only needs to be designed for generating the small forces required for the axial movement MA of the claw ring CL.

In principle, the axial freewheel device FA can also be implemented when using a cycloidal gear CG according to the prior art in a bicycle drive unit DU, and also when using other types of gears such as planetary gears. The axial freewheel device FA is also suitable for other applications in which an efficient, weight-saving and low-noise freewheel is required, see only by way of example for bicycle rear wheel hubs.

FIG. 15 shows, in particular in conjunction with FIG. 13, FIG. 14 and FIG. 17, the special arrangement of the disc-shaped tachometer element TE and the associated tachometer sensor element STM. The tachometer element TE is fixedly connected for conjoint rotation to the bottom bracket shaft SB by means of a tachometer driver DT (see FIGS. 13 to 15).

A tachometer clamping spring SCT ensures that the disc-shaped tachometer element TE, which is mounted rotationally fixedly (for example by a cam arrangement) but axially displaceably on the tachometer driver DT, comes into contact, and remains in contact, with the left output shaft bearing BSL of the output shaft SO.

In this way, the tachometer element TE is axially decoupled from the tachometer driver DT and thus from the bottom bracket shaft SB in relation to tolerance, and instead is referenced on the left output shaft bearing BSL and, with the latter, on the output shaft SO which, via the right output shaft bearing BSR, the right housing cover CHR and the circuit board holder HC, closes the tolerance chain to the circuit board of the electronics assembly AP1, on which the tachometer sensor element STM is arranged. This tolerance chain ensures as constant a minimum distance as possible between the tachometer element TE and the associated tachometer sensor element STM, which contributes to the reliability of the tachometer sensor device TE, STM.

Furthermore, it can be seen in particular in FIGS. 13 and 14 that the tachometer element TE is located inside the axial freewheel device FA, wherein the tachometer element TE and the associated tachometer sensor element STM are arranged on opposite sides of the output disc DA through which the gearbox torque TM2 flows and which can functionally be regarded as the wall of an area or section of the output shaft SO.

In other words, this means that the speed of the bottom bracket shaft SB is measured by detecting the speed of the tachometer element TE through the wall of an output shaft section provided with the output disc DA. For this purpose, the output disc DA may be made of aluminium, while the tachometer element TE may be made of steel. In this way, the speed of the tachometer element TE, whose toothed shape TDT is clearly shown in FIG. 15, can be reliably measured, for example by means of a tachometer sensor element STM based on magnetic field detection, undisturbed by the presence of the output disc DA and undisturbed by any rotation thereof.

This special arrangement of the tachometer element TE within the axial freewheel device FA and on the side of the wall DA of an output shaft section through which the gearbox torque flows opposite the tachometer sensor element STM permits, on the one hand, the particularly space-saving arrangement of the assemblies of the drive unit DU, in particular the axial freewheel device FA, and, on the other hand, the combination of preferably all three sensor devices: 1. tachometer sensor device TMS with tachometer sensor element STM, 2. torque sensor device with torque sensor element CC, TS and 3. speed sensor device with speed sensor element SSP of the drive unit DU in the area of a single electronics assembly AP1.

In particular, this means that essentially all electronic assemblies and electronic components of all three sensor devices can be arranged on a single circuit board device of the electronics assembly AP1, which saves on flying electrical connections and installation space, significantly increases the reliability of the sensor electronics and reduces the costs of manufacturing and assembling the drive unit DU.

The special arrangement of the tachometer element TE within the axial freewheel device FA and on the side of the wall DA of an output shaft section through which the gearbox torque flows opposite the tachometer sensor element STM can, in principle, also be realized when using a cycloidal gear CG according to the prior art in a bicycle drive unit DU, and also when using other types of gears such as planetary gears.

The tachometer sensor element STM may in particular contain a plurality of sensor elements, which are arranged spaced apart in particular in the circumferential direction, with reference to the tachometer element TE. In this way, not only the speed of the tachometer element TE, but also its direction of rotation can be detected, as a result of which the bicycle drive unit DU and any other bicycle components informationally connected to the bicycle drive unit DU, for example a rear derailleur RP of the bicycle power train TP, can be controlled even more reliably in all operating states.

The speed sensor element SSP can be seen in FIG. 8 and FIG. 15. The speed sensor element SSP is used to determine the speed of the rear wheel WB of the bicycle (see FIG. 1) by means of a magnet that is arranged in the area of the rim of the wheel WB or, for example, on an air valve of the rear wheel WB. The integration of the speed sensor element SSP into the drive unit DU eliminates the need for additional flying cables on the bicycle frame and the associated assembly work as well as the associated sources of error during operation of the bicycle. Preferably, an additional magnetic flux director DF is arranged adjacent to the speed sensor element SSP (not shown in FIG. 15, but see FIG. 7). This increases the sensitivity of the speed sensor element SSP and thus the reliability of determining the speed of the bicycle.

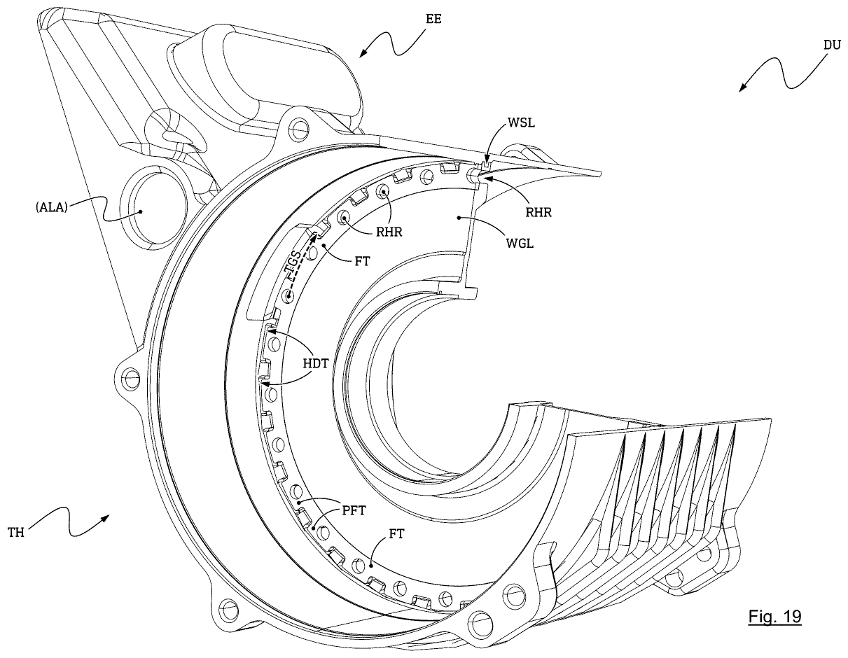

An antenna LED assembly ALA (see also FIG. 19) can also be seen in FIG. 15. The antenna LED assembly ALA is arranged in a through hole of the metallic left housing cover CHL and consists at least partially of a non-metallic material such as a polymer material. The non-metallic material enables wireless controlling communication between the drive unit DU and other components on the bicycle, for example with a rear derailleur RD (see FIG. 1) or with a human machine interface arranged on the bicycle frame or on the bicycle handlebar for operating the drive unit DU or for setting operating options of the drive unit DU.

FIG. 15 furthermore shows two mounting axes FM1, FM2, which define two frame interface axes, in the area of which the drive unit DU is connectable to the bicycle frame 1 (see also FIG. 7 and FIG. 8). Here, the rear frame interfaces I′R arranged in the region of the rear mounting axis FM1 serve to define all of the degrees of freedom of movement of the drive unit DU relative to the frame of the bicycle 1, except the degree of rotational freedom about the rear mounting axis FM1 with the front frame interfaces I′F arranged there.

This means that all of the forces and torques between the drive unit DU and the bicycle frame can be transmitted via the rear frame interfaces I′R, except for torques acting about the rear mounting axis FM1. The remaining degree of rotational freedom about the rear mounting axis FM1 relative to the bicycle frame is defined or can be defined by means of the front frame interfaces I′F via the torque cantilevers TC of the housing covers CHR, CHL of the housing of the drive unit DU.

FIG. 17 also shows two spacer elements that may be made of spring steel, in the form of two roller thrust rings RR, which are arranged between the housing rollers RH and the respective gearbox wall WGL, WGR. Since the housing rollers RH have a slight tendency to move horizontally relative to the drawing against one or both of the gearbox walls WGL, WGR when the motor torque TM1 is applied, among other things due to unavoidable tolerances and/or due to slight elastic-rotational torsion of the cycloidal gear CG, the roller thrust rings RR protect the gearbox walls WGL, WGR, which may be made of aluminium, from wear and, in particular, from chip formation that is harmful to the gear.

FIG. 19 shows the housing tube TH of the further embodiment according to FIGS. 13 to 21 with the left gearbox wall WGL arranged therein (see FIGS. 5 and 6 and FIGS. 10, 13, 14 and 17), and a torque flange FT for supporting the gearbox support torque to be transmitted from the gearbox wall WGL to the housing tube TH.

The gearbox support torque TGS is produced due to the force components FD, which can be seen in FIGS. 2 to 3, acting on the housing rollers RH in the circumferential direction. The sum of said force components FD, or the resulting gearbox support torque TGS, is introduced by the housing rollers RH via the housing roller pins RHP and via the housing roller pin receptacles RHR into the left gearbox wall WGL (see FIGS. 6, 10 and 17). The gearbox support torque TGS is introduced into the torque flange FT and by the latter into the housing tube TH by the housing roller pins RHP (see FIGS. 10, 13 and 17) axially projecting over the gearbox wall WGL on the left-hand side and/or by the left gearbox wall WGL.

The torque flange FT may consist of a vibration-damping material, particularly a corresponding polymer material. This contributes to the reduction in externally perceptible noises of the bicycle drive unit DU and to the damping of torque peaks, which is also favourable for the service life of the cycloidal gear CG.

Furthermore, the torque flange FT allows a freer design of the geometry of the torque recesses HDT on the inner circumference of the housing tube TH (see FIG. 8 and FIG. 13), which would otherwise be comparatively complicated to produce, for example by reaming, due to the confined conditions inside the housing tube TH.

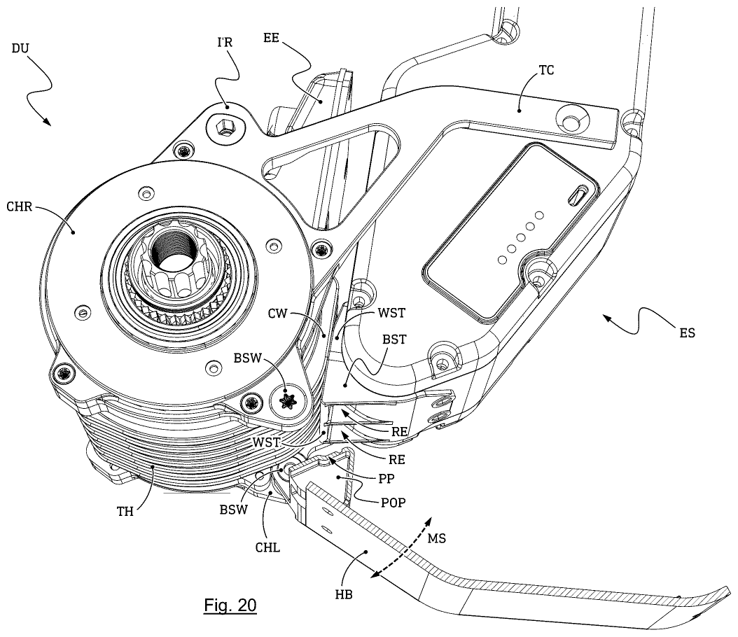

FIG. 20 shows a bicycle drive unit with cycloidal gear, for example, according to FIGS. 1 to 4 and 13 to 19, together with an energy storage device ES (see FIG. 1) in a partially sectioned perspective view.

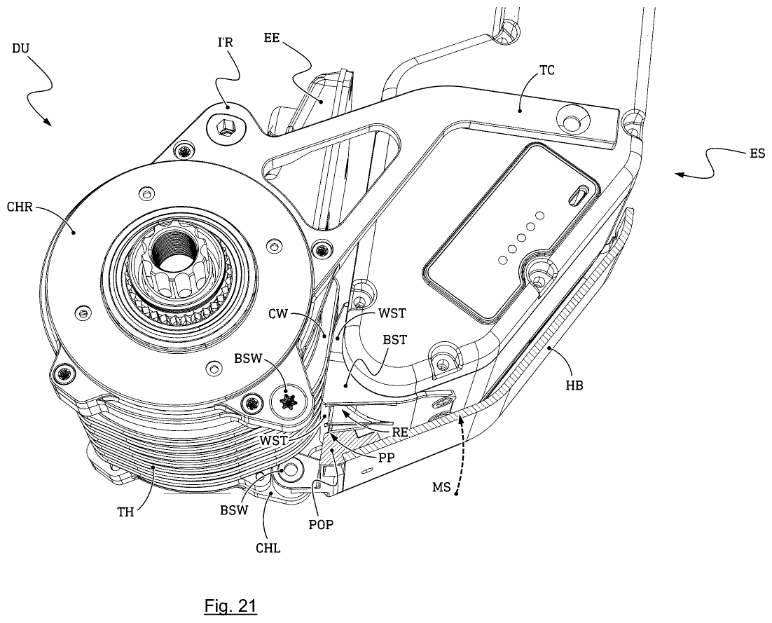

FIG. 21 shows the bicycle drive unit according to FIG. 20 with a closed battery hatch HB. The battery hatch HB is shown in FIGS. 20 and 21, in each case in sectioned form, in order to be able to better see the components and their functions described below.

The battery hatch HB is swivellably connected to the right and left housing covers CHR, CHL by means of swivel bolts BSW. When the battery hatch HB is open, the energy storage device ES can be removed substantially downwards in relation to the drawing. For this purpose, the battery hatch HB can be opened further than shown in FIG. 20.

The energy storage device IT has, in its lower region in relation to the drawing, a stop bracket BST, which can either be connected, for example screwed, to the housing of the energy storage device ES or can be integrally formed with the housing of the energy storage device ES.

The stop bracket BST of the energy storage device ES has a stop wall WST in the area of engagement recesses RE. The stop wall WST can be brought to bear against a shape-corresponding counter wall CW of the housing tube TH when the energy storage device ES is inserted.

After the insertion of the energy storage device ES, the latter is located substantially in the relative position, shown in FIG. 20, to the drive unit DU, in particular to the housing tube TH.

If the battery hatch HB is then closed by a swivel movement MS about the swivel bolts BSW, a press-on projection POP formed, for example, integrally with the battery hatch HB penetrates the engagement recesses RE of the stop bracket BST. This causes the stop wall WST of the stop bracket BST to be pressed onto the corresponding counter wall CW of the housing tube TH. At the same time, the energy storage device ES is pushed upwards, in relation to the drawing, to the correct, final insertion position according to FIG. 20 by a push profile PP, which can be seen in FIG. 20, which interacts for this purpose with the lower end, in relation to the drawing, of the stop wall WST of the stop bracket BST.

The pressing of the stop wall WST of the stop bracket BST onto the corresponding counter wall CW of the housing tube TH by the closing and closed battery hatch HB allows a considerable damping of vibrations and noises, which would otherwise be radiated as sound via the surfaces of the housing tube TH. A contribution is made to this end in particular by the comparatively high mass of the energy storage device ES, in conjunction with the selection of a vibration-damping polymer material for the stop bracket BST of the energy storage device ES.

Various embodiments will be described herein with reference to the drawings. It will be understood that the drawings and the description set out herein are provided for illustration only and do not limit the embodiments as defined by the claims appended hereto and any and all their equivalents. For example, the terms “first” and “second”, “front” and “rear”, “left” and “right” are used for the sake of clarity and not as terms of limitation. Moreover, the terms referred to bicycle mechanisms conventionally mounted to a bicycle and with the bicycle orientated and used in a standard fashion unless otherwise indicated.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. A cycloidal gear for an electric bicycle drive unit, the cycloidal gear comprising:
a drive shaft device with a cam arrangement, and an output shaft device, wherein the drive shaft device and output shaft device are arranged concentrically with respect to one another and with respect to a central axis of the cycloidal gear; and
at least one cycloidal disk device having at least two approximately cycloidal or cylindrical cycloidal tooth arrangements, and at least one opposing cycloid device having at least two approximately cycloidal or cylindrical opposing tooth arrangements, wherein the at least one cycloidal disk device and the at least one opposing cycloidal device are configured for torque-transmitting, mutually positive-locking engagement, and wherein the at least one cycloidal disk device and/or the at least one opposing cycloidal device can be brought into an eccentric-cycloidal relative rolling motion relative to the central axis by means of the cam arrangement of a rotary drive, by means of which in contact areas of drive contact between cycloidal disk profiles of the cycloidal tooth arrangements of the at least one cycloidal disk device and opposing cycloidal profiles of the opposing tooth arrangements of the at least one opposing cycloidal disk device, driving forces can be transmitted in a circumferential direction of the cycloidal gear at least within a respective load flank sub-area of the respective profile of the respective tooth arrangement, wherein at least one of the cycloidal tooth arrangements or the opposing tooth arrangements has a relief contour that is setback relative to the profile along a clearance cut area that is arranged outside the respective load flank sub-area of the respective profile of the respective tooth arrangement.

2. The cycloidal gear of claim 1, wherein the relief contour forms a smooth transition at any one or both of transitions to the profile or transitions to the load flank sub-areas.

3. The cycloidal gear of claim 1, wherein an arc length of the relief contour, relative to the arc length of the profile, is between 60% and 85%.

4. The cycloidal gear of claim 1, wherein the cycloidal gear is a single-disk or a multi-disk cycloidal gear with one or more cycloidal disk devices and two opposing cycloidal devices.

5. The cycloidal gear of claim 1, wherein the cycloidal gear is a compur gear with at least one inner cycloidal disk device, at least one outer cycloidal disk device, and a cam disk that rotates eccentrically in a positive-locking manner with the profiles as an opposing cycloidal device between the profiles of the inner cycloidal disk device and the outer cycloidal disk device, wherein at least one of the inner cycloidal disk device and the outer cycloidal disk device is rotatable about the central axis of the cycloidal gear.

6. The cycloidal gear of claim 1, wherein the cycloidal gear is a cyclo-acbar transmission with at least two cycloidal disk devices, which are rotationally rigidly connected to one another, and two opposing cycloidal devices, wherein at least one of the opposing cycloidal devices is rotatable about the central axis of the cycloidal gear.

7. The cycloidal gear of claim 4, wherein the cycloidal gear has at least two cycloidal disk devices, wherein one of the opposing cycloidal devices forms a rotational output of the cycloidal gear, wherein the output is in engagement with a first cycloidal disk device, and a second opposing cycloidal device forms a torque opposing support which is in engagement with a second cycloidal disk device and is connected to a housing of the cycloidal gear.

8. The cycloidal gear of claim 1, wherein contact areas of at least one of the opposing tooth arrangements comprise polymer material to increase an elasticity in a torque transmission between the cycloidal disk device and the opposing cycloidal device.

9. An electric bicycle drive unit for arrangement in a bottom bracket area of a bicycle frame, the drive unit comprising:
a bottom bracket shaft for mounting pedal cranks;
an electric motor device with a stator device and a rotor assembly arranged on a rotor shaft, wherein the rotor shaft is arranged coaxially to the bottom bracket shaft;
a freewheel arrangement with at least one freewheel device;
a sensor arrangement with at least one sensor device;
at least one electronics assembly for controlling the motor device and/or for processing signals from the sensor device;
an output shaft for transmitting drive power to a bicycle power train; and
a gear device with a cycloidal gear having at least one cycloidal disk device having at least two approximately cycloidal or cylindrical cycloidal tooth arrangements, and at least one opposing cycloid device having at least two approximately cycloidal or cylindrical opposing tooth arrangements, wherein at least one of the cycloidal tooth arrangements or the opposing tooth arrangements has a relief contour that is setback relative to a profile along a clearance cut area that is arranged outside a respective load flank sub-area of a respective profile of the respective tooth arrangement, wherein the cycloidal gear is encapsulated in a liquid-tight manner with respect to the motor device.

10. The drive unit of claim 9, wherein the cycloidal gear is encapsulated in an at least liquid-tight manner with respect to any combination of the motor device, freewheel arrangement, sensor arrangement and electronics assembly.

11. The drive unit of claim 9, wherein the rotor shaft is mounted exclusively in the cycloidal gear, and the rotor assembly is arranged on the rotor shaft in a region of a flying end of the rotor shaft.

12. The drive unit of claim 11, wherein a gear-side end of the rotor shaft is mounted inside a gearbox output shaft.

13. The drive unit of claim 9, further comprising:
an axial freewheel device with coupling elements for decoupling the output shaft from the gear device, wherein the axial freewheel device is disk-shaped and is configured so as to transmit a gearbox torque through the coupling elements in an axial direction, relative to the bottom bracket shaft.

14. The drive unit of claim 13, wherein at least one of the coupling elements of the axial freewheel device is a polymer material.

15. The drive unit of claim 13, wherein the axial freewheel device comprises a control device for active movement of the coupling elements depending on the direction of rotation.

16. The drive unit of claim 13, the drive unit further comprising:
a tachometer sensor device having a tachometer sensor element and a tachometer element connected to the bottom bracket shaft for contactless measurement of a speed of the bottom bracket shaft, wherein the tachometer element and the tachometer sensor element are arranged on opposite sides of a wall of an output shaft section through which a gearbox torque of the drive unit can flow.

17. The drive unit of claim 16, wherein the tachometer element is arranged in an inner area of the axial freewheel device.

18. The drive unit of claim 9, wherein one of the electronics assemblies comprises at least two of: a tachometer sensor device with a tachometer sensor element for measuring a speed of the bottom bracket shaft; a torque sensor device with a torque sensor element for measuring an elastic deformation of a deformation element of an output shaft section; and a tachometer sensor device with a tachometer sensor element for measuring a speed of a bicycle wheel.

19. The drive unit of claim 18, wherein the electronics assembly comprises a circuit board device in a shape of a circular ring, or circular-ring segment, and on which an electronic assemblies and electronic components of the at least two sensor devices are arranged.
